(19) United States
(12) Patent Application Publication
(10) Pub. No.: US 2003/0074224 A1
(43) Pub. Date: Apr. 17, 2003

(54) Health care support system, pet-type health care support terminal, vital data acquisition device, vital data acquisition Net transmission system, health care support method, and portable information terminal with camera

(76) Inventors: Yoshinori Tanabe, Osaka (JP); Hirokazu Genno, Osaka (JP); Masakazu Asano, Osaka (JP); Fumiiki Yoneda, Osaka (JP); Kunihiko Hori, Osaka (JP)

Correspondence Address: Daivid T. Nikaido, RADER, FISHMAN & GRAUER, PLLC, Suite 501, 1233 20th Street, NW, Washington, DC, 20036, US

(21) Appl. No.: 10/267,802

(22) Filed: Oct. 10, 2002

(30) Foreign Application Priority Data
Oct. 11, 2001 (JP) 314391/2001
Oct. 11, 2001 (JP) 314392/2001
Oct. 11, 2001 (JP) 314393/2001
Oct. 11, 2001 (JP) 314394/2001

(51) Int. Cl. G06F 17/60

(52) U.S. Cl. 705/2

(57) ABSTRACT

A pet terminal feeds to a server vital data acquired in a vital data acquisition device and the results of doctor's questions obtained by speech synthesis and speech recognition. The server manages the vital data and the results of doctor's questions for each user. A doctor Y makes connection from a doctor terminal placed in an examination room of a hospital to the server, reads, when a user attends the hospital, the vital data or the like related to the user, and uses the vital data for medical care. Further, the pet terminal automatically makes Net connection when a Net connection request is recognized by speech, and provides data acquired on a Net to the user by speech.

### BACKGROUND OF THE INVENTION

1. Field of the Invention

The present invention relates to a health care support system, a pet-type health care support terminal, a vital data acquisition device, a vital data acquisition Net transmission system, a health care support method, and a portable information terminal with a camera, which are particularly suitable for prevention or the like of life-style related diseases such as diabetes.

In recent years, as systems effective in preventing, for example, life-style related diseases such as diabetes, systems for acquiring various types of vital data at home without requiring hospital visit and making good use of the data for health care have been expected. Further, systems for asking doctor's questions at home without hospital visit and acquiring answer data, to make good use of the data for health care have been expected.

However, to acquire the answer data corresponding to the doctor's questions at home can dissolve a time period required to attend a hospital for acquiring the answer data and discontent with a long wait in a waiting room of the hospital but requires a considerable intention to continuously acquire the data. In many cases, the user is liable to neglect the acquisition of the data, so that sufficient data are incomplete. Unless the answer data acquired at home can be easily utilized on the doctor side, medical care cannot be made efficient.

Meanwhile, calories which the user takes in by meals and between-meal snacks can be changed into data in addition to the above-mentioned vital data related to the user, so that user's health can be more easily managed. However, it is very difficult for the user to calculate the calories. Therefore, it is considered that the contents of the meal are photographed using a portable information terminal with a camera, and are transmitted to a terminal on the side of a nutritionist, thereby causing the nutritionist to alternatively calculate the calories.

In calculating the calories by an image of the meal, however, there is such discontent that the calories cannot be accurately calculated. If a doctor can utilize acquired calorie data, medical care can be made efficient.

In view of the above-mentioned circumstances, an object of the present invention is to provide a health care support system and a pet-type health care support terminal, in which data such as answer data or vital data acquired at home Can be easily utilized on the side of a doctor, for example, to contribute toward increasing the efficiency of medical care, the improvement in the ratio of the number of answers to the number of questions can be expected, and information obtained through a Net connection operation and the Net can be easily provided to a user, for example.

Another object of the present invention is to provide a vital data acquisition device and a vital data acquisition network transmission system, in which a data acquisition operation or the like can be easily performed.

Still another object of the present invention is to provide a health care support system and a portable information terminal with a camera, in which a nutritionist can exactly calculate the calories by image of the meal and a doctor or the like can effectively utilize acquired calorie data.

### SUMMARY OF THE INVENTION

A health care support system according to the present invention is characterized in that a medical-side information processor placed on the side of a medical expert and a health care support terminal placed on the side of a user are connected to a server through a network, the health care support terminal comprising speech output means for outputting speech on the basis of speech synthesis or speech data, to ask the user a question fixedly stored previously and/or a question added by the server, acquire an answer to the question by information acquisition means for acquiring information returned from the user, and automatically transmit answer data to the server, and the server holding a list of questions for each user, transmitting data representing the added question to the health care support terminal, storing at least user health related information constructed by managing the answer data for each user, transmitting at least the user health related information to the medical-side information processor in response to a request from the information processor, and receiving the added question for each user inputted from the medical-side information processor.

In the above-mentioned configuration, the user can enjoyably answer the questions by speech from the health care support terminal, thereby making it possible to increase the ratio of the number of answers to the number of questions. Since the acquired answer data is automatically transmitted, it does not take the user time and labor to transmit the data. The questions fixedly stored previously exist at the health care support terminal. Accordingly, the frequency of the transmission of the question data to the health care support terminal from the server can be reduced. The medical expert can access the sever in the medical-side information processor, and register the added question to the user in the server. Further, the answer data can be read as the user health related information constructed by managing the answer data for each user by accessing the server. When the user visits the medical expert, the medical expert can see the answer to the question, which has already been asked, in the medical-side information processor even if he or she does not ask the question again then and there, thereby making it possible to efficiently provide medical care.

The health care support system may be so configured that the list of questions for each user from the server is received in the medical-side information processor, and at least one of input of the term of the question, input of the frequency of the question, input of nonuse/use of the existing question, and input of the added question can be performed on the list of questions.

A pet-type health care support terminal according to the present invention is a pet-type health care support terminal having a imitative biological form, characterized by comprising speech output means for outputting speech on the basis of speech synthesis or speech data; means for acquiring vital data related to a user directly or indirectly through auxiliary equipment; storage means for fixedly holding a plurality of questions as well as holding, when an added question is received, the question; means for asking the user a question using the speech output means, detecting information returned from the user, and acquiring an answer to the question; means for randomizing the order of the questions fixedly stored; and means for making automatic wireless Net connection to transmit and receive data to and from a server.

In the above-mentioned configuration, the user feels friendly toward the pet-type health care support terminal having the imitative biological form, and can hear and enjoyably answer the questions by speech output from the terminal, thereby making it possible to contribute toward improving the ratio of the number of answers to the number of questions. Since the vital data and the answer data which have been acquired are automatically transmitted, it does not take the user time and labor to transmit the data. Since the data transmission is made by the wireless Net connection, the pet-type health care support terminal can be carried about and placed in a favorable place. In the pet-type health care support terminal, the questions fixedly stored previously exist. Accordingly, the frequency of the transmission of the question data to the pet-type health care support terminal from the server can be reduced. The order of the questions fixedly stored can be randomized and fed to the user, thereby making it possible to reduce the situations where the user is tired of the questions.

The held questions may be outputted in several days such that they are not overlapped with one another.

In a case where the added question is received, the added question may be outputted prior to the questions fixedly held.

Judgment which of “YES” and “NO” is an answer requiring attention with respect to the contents of each of the questions may be held, to notify, when the answer is the answer requiring attention, the user of the answer.

In the health care support system, the health care support terminal may be the above-mentioned pet-type health care support terminal.

A health care support system according to the present invention is characterized in that a medical-side information processor placed on the side of a medical expert and a health care support terminal placed on the side of a user are connected to a server through a network, the health care support terminal comprising speech output means for outputting speech on the basis of speech synthesis or speech data, to make speech, acquire vital data related to a user directly or indirectly through auxiliary equipment, and automatically transmit the vital data to the server, and the server storing at least user health related information constructed by managing the vital data for each user, to transmit at least the user health related information to the medical-side information processor in response to a request from the information processor.

In the above-mentioned configuration, the user can enjoyably come in contact with the health care support terminal by the speech function of the terminal, thereby making it easy to continuously acquire the vital data. Since the acquired vital data is automatically transmitted, it does not take the user time and labor to transmit the data. A medical expert can access the server in the medical-side information processor, and read the vital data as the user health related information constructed by managing the vital data for each user. When the user visits the medical expert, daily vital data related to the user can be seen in the medical-side information processor, thereby making it possible to efficiently provide medical care.

A health care support system according to the present invention is characterized in that a medical-side information processor placed on the side of a medical expert and a health care support terminal placed on the side of a user are connected to a server through a network, the health care support terminal comprising speech output means for outputting speech on the basis of speech synthesis or speech data, to ask a user a question, acquire an answer to the question by information acquisition means for acquiring information returned from the user, and transmit answer data to the server, and the server storing at least user health related information constructed by managing the answer data for each user, to transmit at least the user health related information to the medical-side information processor in response to a request from the information processor.

In the above-mentioned configuration, the user can enjoyably answer the questions by speech from the health care support terminal, thereby making it possible to increase the ratio of the number of answers to the number of questions. Since the acquired answer data is automatically transmitted, it does not take the user time and labor to transmit the data. A medical expert can access the sever in the medical-side information processor, and read the answer data as the user health related information constructed by managing the answer data for each user. When the user visits the medical expert, the medical expert can see the answer to the question, which has already been asked, in the medical-side information processor even if he or she does not ask the question then and there, thereby making it possible to efficiently provide medical care.

A health care support system according to the present invention is characterized in that a medical-side information processor placed on the side of a medical expert and a health care support terminal placed on the side of a user are connected to a server through a network, the health care support terminal comprising speech output means for outputting speech on the basis of speech synthesis or speech data, to ask the user a question, acquire an answer to the question by information acquisition means for acquiring information returned from the user, acquire vital data related to the user directly or indirectly through auxiliary equipment, and automatically transmit answer data and the vital data to the server, and the server storing at least user health related information constructed by managing the answer data and the vital data for each user, to transmit at least the user health related information to the medical-side information processor in response to a request from the information processor.

In the above-mentioned configuration, both the vital data and the answer data can be obtained by the health care support terminal, and are stored in the server. A medical expert can access the server in the medical-side information processor, and read both the answer data and the vital data as the user health related information constructed by managing the vital data and the answer data for each user. When the user visits the medical expert, both the answer data and the daily vital data related to the user can be seen in the medical-side information processor, thereby making it possible to efficiently provide medical care.

In any of the above-mentioned health care support systems, the server may incorporate examination data at the time of hospital visit of the user which is inputted by the medical-side information processor as the contents of the user health related information.

When the user visits the medical expert, therefore, examination data at the time of the previous hospital visit can be seen in the medical-side information processor in addition to the answer data and/or the daily vital data related to the user, thereby making it possible to efficiently provide medical care.

In order to solve the above-mentioned problem, a pet-type health care support terminal according to the present invention is a pet-type health care support terminal having a imitative biological form, characterized by comprising speech output means for outputting speech on the basis of speech synthesis or speech data; means for acquiring vital data related to a user directly or indirectly through auxiliary equipment; means for asking the user a question using the speech output means, detecting information returned from the user, and acquiring an answer to the question; means for making wireless Net connection, to automatically transmit the vital data or answer data; connection means for automatically making, when a Net connection request is recognized by speech recognition, the wireless Net connection; and means for outputting information obtained by the wireless Net connection by speech in the speech output means.

In the above-mentioned configuration, the user feels friendly toward the pet-type health care support terminal having the imitative biological form, and can hear the speech and enjoyably answer the questions by the speech output from the terminal, thereby making it possible to contribute toward improving the ratio of the number of answers to the number of questions and continuously acquiring the vital data. Since the vital data and the answer data which have been acquired are automatically transmitted, it does not take the user time and labor to transmit the data. The data transmission is made by the wireless Net connection. Accordingly, the pet-type health care support terminal can be carried about and placed in a favorable place. Further, by the Net connection function by the speech recognition, Net connection by a user's intention other than the transmission of the vital data or the like can be made without comprising a keyboard, a mouse, etc. The user can recognize information (e.g., weather information) obtained by the Net connection by speech. It is considered that a lot of aged people utilize the pet-type health care support terminal. The pet-type health care support terminal makes Net connection in place of Net connection by a personal computer which such aged people are not good at. Accordingly, an affinity with the pet-type health care support terminal is further increased, and the ratio of the number of answers to the number of questions is also improved. Further, this can contribute toward continuing to acquire the vital data.

A pet-type health care support terminal according to the present invention is a pet-type health care support terminal having a imitative biological form, characterized by comprising speech output means for outputting speech on the basis of speech synthesis or speech data; means for acquiring vital data related to a user directly or indirectly through auxiliary equipment; means for asking the user a question using the speech output means, detecting information returned from the user, and acquiring an answer to the question; means for making wireless Net connection, to automatically transmit the vital data or answer data; connection means for automatically making, when a switch provided in a predetermined portion of the face or the body in the imitative biological form is operated, the wireless Net connection; and means for outputting information obtained by the wireless Net connection by speech in the speech output means.

Even in such a configuration, the same function as described above is obtained.

A pet-type health care support terminal according to the present invention is a pet-type health care support terminal having a imitative biological form, characterized by comprising speech output means for outputting speech on the basis of speech synthesis or speech data; means for acquiring vital data related to a user directly or indirectly through auxiliary equipment; means for asking the user a question using the speech output means, detecting information returned from the user, and acquiring an answer to the question; means for making wireless Net connection, to automatically transmit the vital data or answer data; and notification means holding information as to which of “YES” and “NO” is an answer requiring attention with respect to the contents of each of questions for notifying, when the answer is the answer requiring attention, the user of the answer.

In the above-mentioned configuration, in a case where the questions spoken from the pet-type health care support terminal are answered, when an answer requiring attention is made, the user is notified of the answer requiring attention. Accordingly, the user can easily check his or her health. Further, the health is easily checked then and there, thereby making it possible to expect the improvement in the ratio of the number of answers to the number of questions.

A pet-type health care support terminal according to the present invention is a pet-type health care support terminal having a imitative biological form, characterized by comprising speech output means for outputting speech on the basis of speech synthesis or speech data; means for acquiring vital data related to a user directly or indirectly through auxiliary equipment; notification means holding values requiring attention with respect to one or a plurality of vital data for notifying, when the vital data related to the user exceeds the value requiring attention, the user of the vital data; means for asking the user a question using the speech output means, detecting information returned from the user, and acquiring an answer to the question; and means for making wireless Net connection, to automatically transmit the vital data and the answer data.

In the above-mentioned configuration, in a case where the vital data is fed to the pet-type health care support terminal, when a value exceeding the value requiring attention is detected, the user is notified of the value requiring attention. Accordingly, the user can easily check his or her health. Further, the health is easily checked then and there, thereby making it possible to contribute toward continuing to acquire the vital data.

The pet-type health care support terminal comprising the speech recognition means, the answer to the question may be acquired in the speech recognition means

In the pet-type health care support terminal comprising the speech recognition means, user feature information related to the features of the user may be acquired from the contents of a conversation with the user or the contents of the question and the answer using speech recognition and speech output.

In such a configuration, Net retrieval may be performed using the user feature information as a key.

The pet-type health care support terminal may be used as the health care support terminal in the above-mentioned health care support system.

It goes without saying that the pet-type health care support terminal not having any of the configurations but merely having the imitative biological form may be used as the health care support terminal in the above-mentioned health care support system.

In the health care support system, a nutritionist-side information processor placed on the side of an expert related to nutrition may be connected to the server through a network, and the server may incorporate calorie intake information related to calories taken in which is inputted in the nutritionist-side information processor as the contents of the user health related information.

Consequently, the medical expert can access the server in the medical-side information processor and also read the calorie intake information as the user health related information constructed by managing data for each user. When the user visits the medical expert, the calorie intake information related to the user can be also seen in the medical-side information processor, thereby making it possible to efficiently provide medical care.

Furthermore, in the above-mentioned health care support system, the calorie intake information registered in the server may be transmitted to the health care support terminal placed on the side of the user, and the calories taken in may be reported by speech at the health care support terminal.

Consequently, not only the medical expert but also the user can know the calories taken in without laborious calculation.

A vital data acquisition device according to the present invention is characterized by comprising a plurality of data communication ports for receiving vital data outputted by each vital measurement device; an instruction key for selecting the vital measurement device and issuing a data registration instruction; display means for displaying a message; and means for transmitting data acquired from the vital measurement device by wireless.

In the above-mentioned configuration, vital measurement devices such as a blood pressure gauge, a blood sugar gauge, and a exercise gauge are connected to the vital data acquisition device through the data communication terminal. Judgment as to which of the vital measurement devices is used to acquire the vital data can be made by the instruction key for selection. The display of the acquired vital data, the designated message, or the like can be presented to the user by the display means for displaying the message. The vital data fed from each of the measurement devices is fed to the health care support terminal by the operation of the key, for example, by wireless (e.g., infrared rays). Consequently, a data acquisition operation can be more easily performed using the general blood pressure gauge or the like, as compared with a case where the health care support terminal itself is caused to have the vital measurement devices. With respect to the health care support terminal, healing processing such as the function of a conversation with the user can be easily expanded.

The vital data acquisition device may comprise a numeric input key for manually inputting data.

With respect to a device having no data communication function and a device meeting different specifications, for example, the data cannot be received by the data communication terminal but can be manually inputted.

The vital data acquisition device may be so configured that the date can be inputted using the numeric input key, and vital data and data representing the inputted date are transmitted by wireless when the key for issuing the data registration instruction is operated in a case where the date is displayed on the display means.

It may be so configured as to comprise a button meaning emergency, to transmit information meaning emergency by wireless when the button is operated.

Further, it may be so configured as to comprise a button meaning consultation, to transmit information meaning consultation by wireless when the button is operated.

A vital data acquisition Net transmission system according to the present invention is characterized by comprising any of the above-mentioned vital data acquisition devices; and a terminal receiving data transmitted by wireless from the vital data acquisition device and transmitting the data to the server at the time of Net connection.

A vital data acquisition Net transmission system according to the present invention is characterized by comprising the above-mentioned vital data acquisition device comprising the button meaning emergency; and a terminal for making connection to a predetermined contact address when the information meaning emergency transmitted by wireless from the vital data acquisition device is received, to perform notification processing.

A vital data acquisition Net transmission system according to the present invention is characterized by comprising the above-mentioned vital data acquisition device comprising the button meaning consultation; and a terminal for making connection to a predetermined contact address when the information meaning consultation transmitted by wireless from the vital data acquisition device is received, to perform telephone conversation processing.

The terminal may comprise Net connection means by wireless.

Further, the terminal may have a imitative biological form.

The terminal may output speech on the basis of speech synthesis or speech data.

In the configuration having the speech output function, the terminal may notify, when there is one, which has not been acquired yet, of the vital data which are scheduled to be acquired, the user of the vital data by speech output.

Further, in the vital data acquisition device, wireless transmission may be performed simultaneously using both infrared rays and radio waves.

In the vital data acquisition Net transmission system, it is desirable in making the transmission/receiving of the information reliable that both infrared rays and radio waves are simultaneously received.

A health care support method according to the present invention is characterized in that a medical-side information processor placed on the side of a medical expert, a portable information terminal with a camera placed on the side of a user, and a nutritionist-side information processor placed on the side of an expert related to nutrition are connected to a server through a network, the user photographing the contents of a meal to be taken at the portable information terminal with a camera, to transmit meal image data representing an image of the meal to the server, the expert related to nutrition accepting the meal image data from the server in the nutritionist-side information processor, to display the meal image, and calculating calories taken in, to transmit calorie intake information to the server, the server storing the calorie intake information as one of user health related information, to transmit at least the user health related information to the medical-side information processor in response to a request from the information processor.

In the above-mentioned configuration, the user himself or herself is freed from time and labor to calculate the calories of a taken meal. Further, the medical expert can access the server in the medical-side information processor, and read the calorie intake information as one of the user health related information constructed by managing data for each user. When the user visits the medical expert, daily calorie intake information related to the user can be seen in the medical-side information processor, thereby making it possible to efficiently provide medical care.

The user may transmit to the server meal memo data representing a meal memo together with the meal image data, and the expert related to nutrition may accept the meal image data and the meal memo data from the server in the nutritionist-side information processor to display the meal image and the meal memo, to calculate calories taken in.

Consequently, it is possible to reduce inaccuracy in calculating the calories by only the meal image.

The user may photograph, with respect to one meal, at least the whole contents of the meal, to transmit meal image data representing an image of the meal to the server, and the expert related to nutrition may accept the meal image data with respect to one meal from the server in the nutritionist-side information processor to display the meal image, to calculate calories taken in.

Further, the user may photograph, with respect to one meal, at least a state where the meal has not been taken and a state where the meal is left over, to transmit a plurality of meal image data to the server, and the expert related to nutrition may accept the plurality of meal image data with respect to one meal from the server in the nutritionist-side information processor to display the meal image, to calculate calories taken in.

Consequently, the images of the whole contents of the meal and the meal which is left over can be fed to the expert related to nutrition, thereby making it possible to enhance accuracy in calculating the calories taken in.

The user may photograph, with respect to one meal, at least the whole contents of the meal and parts of contents of the meal, to transmit a plurality of meal image data to the server, and the expert related to nutrition may accept the plurality of meal image data with respect to one meal from the server in the nutritionist-side information processor to display the meal image, to calculate calories taken in.

Consequently, an image of the whole contents of the meal and parts of the contents of the meal (e.g., an image of an accompanying dish to be a main dish) can be fed to the expert related to nutrition, thereby making it possible to increase accuracy in calculating the calories taken in.

Photographing time information related to the time when the meal is photographed may be added to the meal image data.

In such a configuration, the server may estimate the time when the user takes the meal on the basis of the photographing time information added to the meal image data.

Consequently, the user himself or herself is freed from time and labor to enter and transmit the meal time.

When the photographing time information is added to the meal image data, a health care support terminal placed on the side of the user may be connected to the server through the network, the health care support terminal may transmit blood sugar level data representing the blood sugar level of the user, together with blood sugar level data acquisition time information related to the time when the blood sugar level data is acquired, to the server, and the server may estimate the type of the blood sugar level data on the basis of the photographing time information added to the meal image data and the blood sugar level data acquisition time information.

Consequently, the user himself or herself is freed from time and labor to input and transmit the type “blood sugar level after lunch”.

Information indicating that no meal is taken may be transmittable to the server in place of the meal image.

Consequently, the nutritionist can easily know whether or not the user forgets to transmit the meal image or whether or not the user does not take a meal.

A portable information terminal with a camera according to the present invention is characterized by comprising means for adding data representing the photographing date, which includes time, to an image obtained by photographing in the camera and recording the image and the date data; means for accepting input of the meal date; means for thumbnailing the image picked up on the day on the basis of the inputted meal date, to display the thumbnailed image together with the photographing time; means for accepting the designation of a plurality of thumbnailed images; means for making Net connection, to transmit data representing the plurality of designated thumbnailed images.

In such a configuration, information related to the photographing time added to data representing the meal image may be also transmitted.

The portable information terminal with a camera may further comprise designation means for designating an item indicating that no meal is taken, and means for transmitting to the server information indicating that no meal is taken when the item is designated.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an explanatory view showing a health care support system according to an embodiment of the present invention;

FIG. 2 is a block diagram of a pet-type health care support terminal according to the embodiment of the present invention;

FIG. 3 is an explanatory view showing an example of speech data related to doctor's questions;

FIG. 4 is a block diagram showing the configuration of a communication adaptor combined with a remote control;

FIG. 5 is an explanatory view showing an example of a screen indicating the registration of initial data related to a patient;

FIGS. 6A and 6B are explanatory views showing an example of an operation screen of a nutritionist terminal;

FIG. 7 is an explanatory view showing an example of an operation screen of a doctor terminal;

FIG. 8 is an explanatory view showing an example of an operation screen corresponding to a designated patient;

FIGS. 9A and 9B are explanatory views showing an example of a screen indicating detailed data related to a designated patient;

FIG. 10 is an explanatory view showing an example of a screen indicating the profile of a designated patient;

FIG. 11 is an explanatory view showing an example of a screen indicating examination information related to a designated patient;

FIG. 12 is an explanatory view showing an example of a screen indicating medical care information related to a designated patient;

FIGS. 13A and 13B are explanatory views showing an example of a display screen of a PDA with a camera;

FIG. 14 is an explanatory view showing an example of speech data related to doctor's questions;

FIG. 15 is a flow chart showing the contents of processing for asking doctor's questions;

FIGS. 16A and 16B are explanatory views showing an example of a screen indicating the registration of doctor's questions;

FIG. 17 is an explanatory view showing a communication adaptor combined with a remote control in enlarged fashion as well as showing a connected state with each vital measurement device;

FIG. 18 is an explanatory view showing the state transition of a communication adaptor combined with a remote control;

FIG. 19 is a flow chart showing the schematic processing of a communication adaptor combined with a remote control;

FIG. 20 is a flow chart showing blood pressure data acquisition processing by a communication adaptor combined with a remote control;

FIG. 21 is an explanatory view showing a message displayed on an LCD of a communication adaptor combined with a remote control in the processing shown in FIG. 20; and

FIG. 22 is a flow chart showing processing for inputting the measurement date into a communication adaptor combined with a remote control.

### DESCRIPTION OF THE PREFERRED EMBODIMENTS

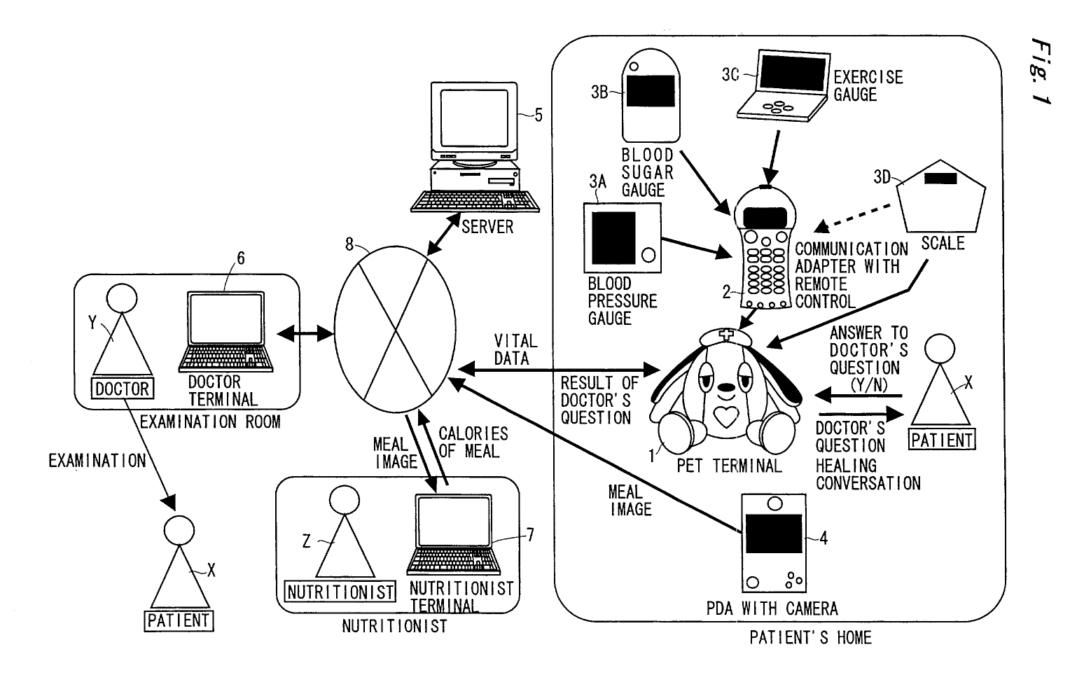

A health care support system, a pet-type health care support terminal, a vital data acquisition device, a vital data acquisition Net transmission system, a health care support method, and a portable information terminal with a camera according to an embodiment of the present invention will be described on the basis of FIGS. 1 to 22.

FIG. 1 is an explanatory view showing the health care support system according to the present embodiment. In a user's home (a patient's home), a pet-type health care support terminal (hereinafter referred to as a pet terminal) 1, a communication adaptor combined with a remote control 2, a vital data acquisition device 3 (a blood pressure gauge 3A, a blood sugar gauge 3B, a exercise gauge 3C, a scale 3D, a thermometer (not shown), etc.), and a PDA with a camera (a portable information terminal with a camera) 4 are placed. A personal computer having a communication environment (hereinafter referred to as a doctor terminal) 6 is placed in an examination room of a hospital. A personal computer having a communication environment (hereinafter referred to as a nutritionist terminal) 7 is placed in a nutritionist's home. The pet terminal 1, the PDA with a camera 4, the doctor terminal 6, and the nutritionist terminal 7 are connected to a server 5 through a network (the Internet in the present embodiment) 8.

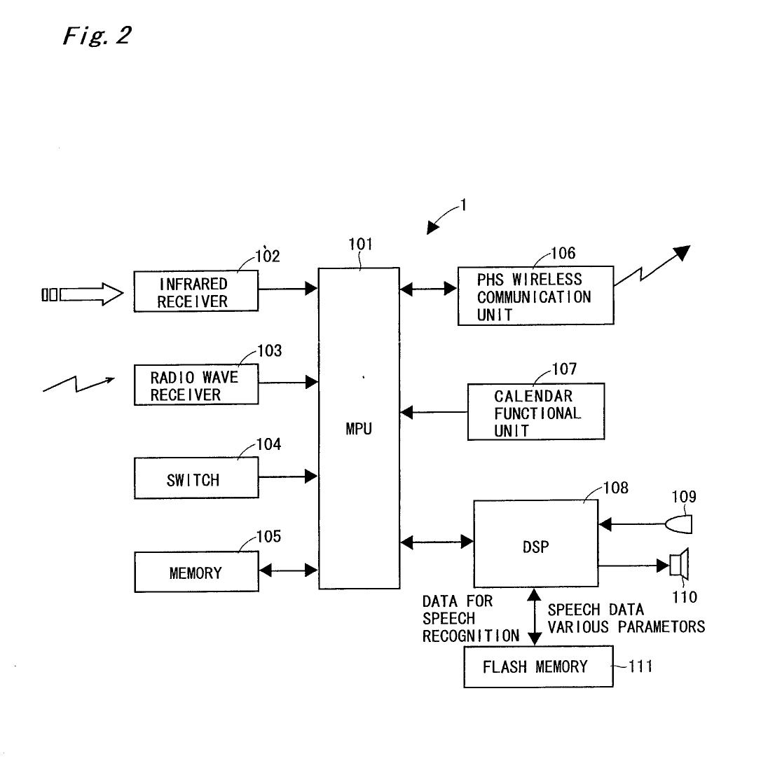

FIG. 2 is a block diagram showing the configuration of the pet terminal 1. An infrared light receiver 102 acquires vital data and data representing the date on which the vital data is acquired (examination date data) sent from the communication adaptor combined with a remote control 2 by infrared rays, and feeds the vital data or the like to an MPU (Microprocessing Unit) 101. A radio wave receiver 103 acquires weight data which is vital data sent by weak radio waves from the scale 3D and data representing the date on which the weight data is acquired, and feeds the weight data or the like to the MPU 101. The MPU 101 stores the vital data or the like in a memory 105. Switches 104 are provided at the foot or the like of the pet terminal 1, and are operated by a user grasping the foot or the like. An ON signal generated by the operation is fed to the MPU 101. The MPU 101 may, in some cases, process the operations of the switches 104 as answers “YES” or “NO” to doctor's questions, described later, or a Net connection command.

A PHS wireless communication unit 106 carries out Internet connection by wireless, to perform processing for transmitting to the server 5 data which it is instructed to transmit by the MPU 101 (e.g., the above-mentioned vital data, data representing the acquisition date, and data representing the results of doctor's questions, described later, etc.) and processing for receiving the data from the server 5 and feeding the received data to the MPU 101. A calendar functional unit 107 feeds information related to the current date (current date information), etc. to the MPU

A DSP (Digital Signal Processor) 108 serves as functional parts for speech output and speech recognition. A flash memory 111 stores speech data, data for speech recognition, various parameter data, and so forth. The DSP 108 performs speech signal generation processing when it receives a speech instruction from the MPU 101, and feeds the speech signal to a speaker 110. As the form of speech processing, there is processing for acquiring, when a code “third” is received from the MPU 101, for example, speech data “Good Morning” stored as the “third” from the flash memory 111 and changing the speech data into speech or processing for receiving text data “Good Morning” and reading the text data. Of course, processing for receiving a speech file and changing the received speech file into a speech signal can be also performed. The DSP 108 subjects the speech inputted from a microphone 109 to analog-to-digital (A/D) conversion, and acquires, out of data for speech recognition stored in the flash memory 111, candidates for words which are judged to be close to obtained digital data for speech recognition on the basis of the A/D conversion data, to perform speech recognition. The results of the speech recognition are fed to the MPU 101.

Although the appearance of the pet terminal 1 is simply illustrated in FIG. 1, the pet terminal 1 has an appearance portion which is recognized as a face and a body portion such as hands and feet in the present embodiment, there is no wired state at the pet terminal 1, except in the case of charging, and the pet terminal 1 is made lightweight. Accordingly, a user (patient) X can carry about the pet terminal 1 anywhere. Since the pet terminal 1 has a imitative biological form, the user X does not see the pet terminal 1 as a machine and can speak to the pet terminal 1 with a natural feeling. Further, on the appearance of the pet terminal 1, switches are not exposed and a device such as a keyboard, a mouse, or a CRT is not provided. Accordingly, an affinity with the pet terminal 1 is further increased.

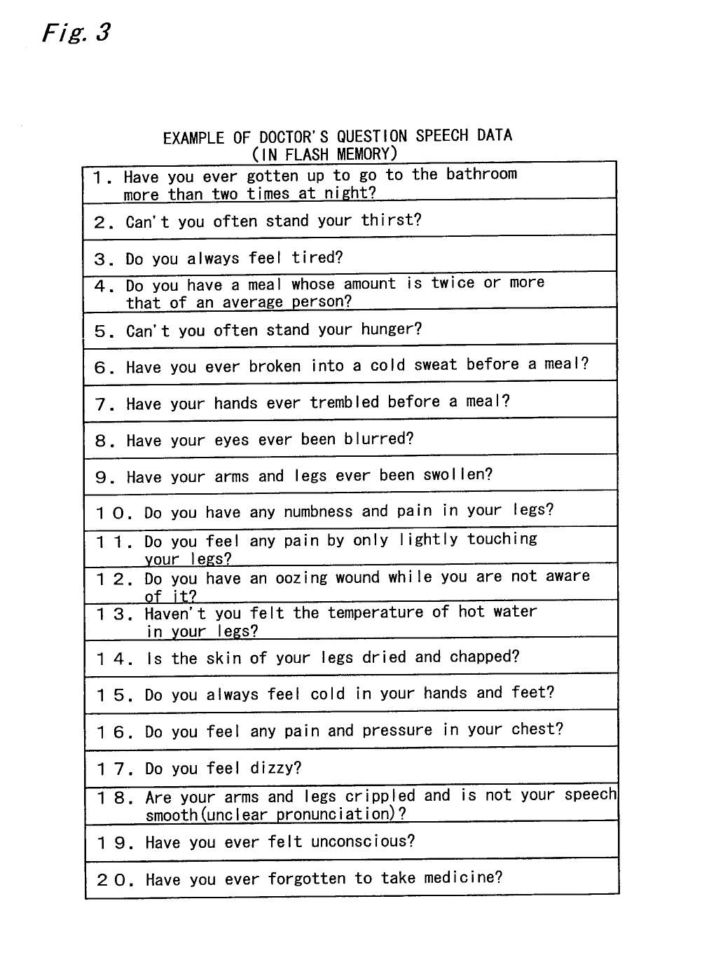

The pet terminal 1 can carry on a simple conversation by recognizing words spoken from the user X and returning suitable words using a speech recognition function and a speech output function by the MPU 101 or the like. Further, it is possible to ask simple doctor's questions by speech output, acquire answers to the questions by speech recognition, and store the answers in the memory 105. The answer “Yes” or “No” to the doctor's questions can be also distributed among the switches 104 provided at the right and left feet. The contents of the doctor's questions are shown in FIG. 3. The contents of the doctor's questions are stored as speech data in the flash memory 111.

The MPU 101 obtains information related to the current date or the like from the calendar functional unit 107, to turn a timer on at 0:00 a.m. every day, for example, give a start command to the PHS wireless communication unit 106, and automatically make wireless Internet connection. The vital data and data representing the results of doctor's questions which have been so for acquired are read out of the memory 105, and are transmitted to the server 5 through the PHS wireless communication unit 106.

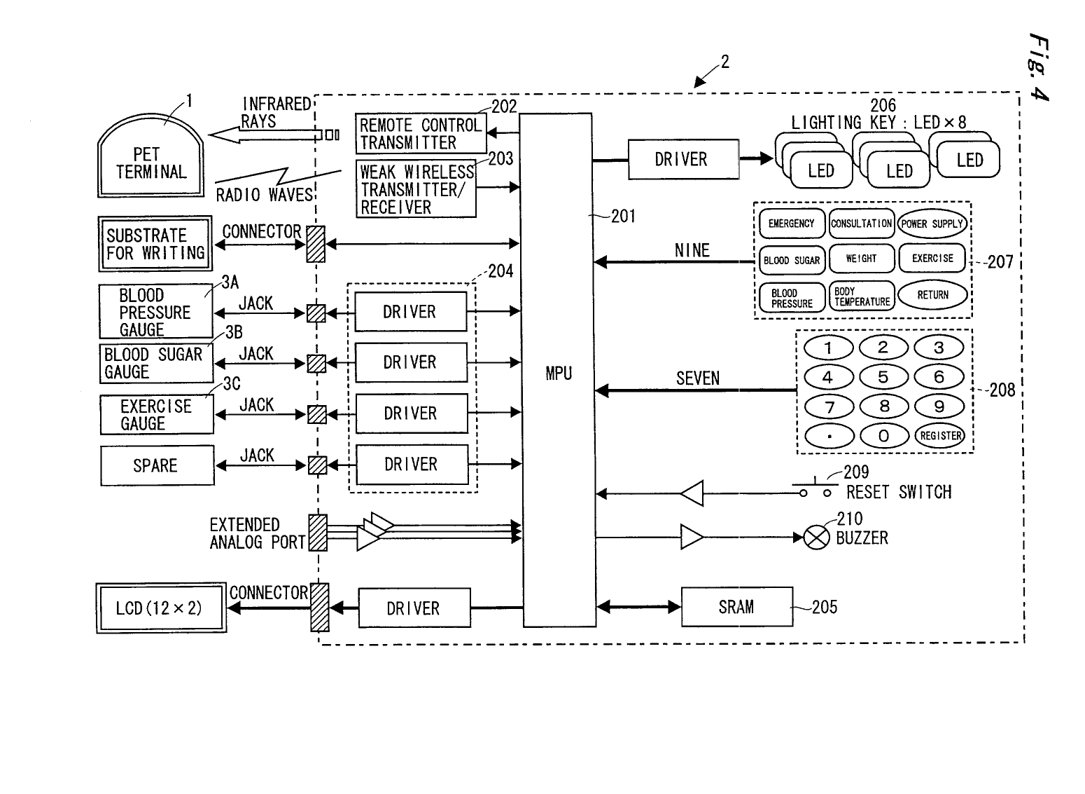

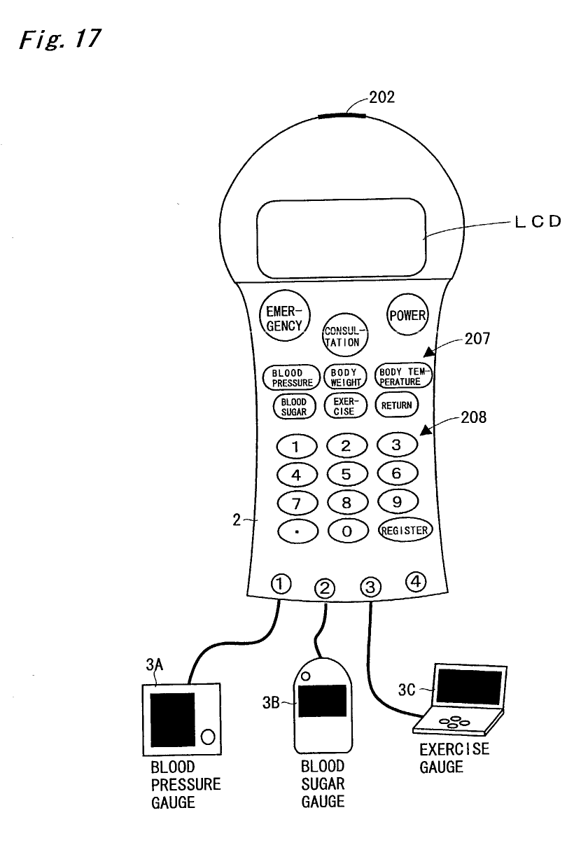

FIG. 4 is a block diagram showing the configuration of the communication adaptor combined with a remote control 2. FIG. 17 illustrates the communication adaptor combined with a remote control 2 in enlarged fashion, and illustrates a state where the blood pressure gauge 3A, the blood sugar gauge 3B, and the exercise gauge 3C are respectively connected to data communication ports \mathring{1} to \mathring{3}. The blood pressure gauge 3A, the blood sugar 3B, and the exercise gauge 3C are connected to the communication adaptor combined with a remote control 2, respectively, through jack codes, and vital data and acquisition time data which are measured by each of the gauges are fed to an MPU 201 through a driver 204 in serial communication. The MPU 201 stores the vital data or the like in an SRAM 205. A group of functional keys 207 and a group of ten-keys 208 are provided in the appearance portion of the communication adaptor combined with a remote control 2, and an LED 206 is incorporated into the predetermined key. Further, a reset switch 209 and a buzzer 210 are connected to the MPU 201.

Operation signals for the respective keys and the reset switch 209 are fed to the MPU 201. The vital data can be also manually inputted by using each of the keys. In the present embodiment, body temperature measured by the thermometer shall be manually inputted. A vital data measurement device can be selected, for example, by operating the functional keys, and the vital data is read out of the SRAM 205 by operating the register key (enter key) in the group of ten-keys 208, to start to transmit the read vital data to the pet terminal 1 by infrared rays using a remote control transmission unit 202. The communication adaptor combined with a remote control 2 may be so configured as to receive by wireless weight data in a weak wireless transmitter/receiver 203 and feed the weight data to the pet terminal 1 by the infrared transmission.

The PDA with a camera 4 comprises a wireless Net connection function, a digital camera function, and so forth. The PDA with a camera 4 can be used to transmit to the server 5 text data (the contents of a meal, etc.) inputted by the user X and an image obtained by photographing a meal to be taken by the user X. Data representing the image picked up using the PDA with a camera 4 is recorded on an internal memory or the like after data representing the photographing date, which includes time, is added thereto. In the present embodiment, the PDA with a camera 4 shall be a device dedicated to meal image transmission, and the image to be picked up shall be an image representing the contents of the meal. The user uses the PDA with a camera 4, to photograph the contents of the meal. In the photographing of the contents of the meal, a plurality of images shall be picked up. The contents of the plurality of images picked up include the whole image of the contents of the meal, an image of an accompanying dish to be a main dish, the whole image after eating in a case where the meal is left over. If speech recording can be performed at the time of the photographing, the contents of the meal (e.g., a main dish is a hamburger) may be spoken at the time of the photographing.

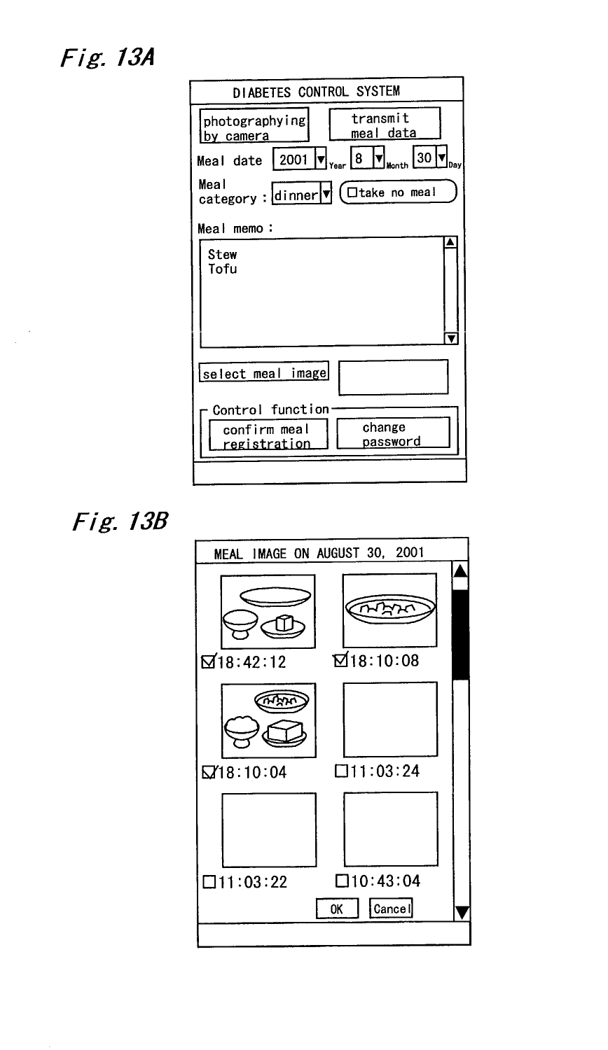

FIG. 13A illustrates an example of a display screen of the PDA with a camera 4. The screen may be an initial screen, or may be displayed by operating a “transmit contents of meal” button on a menu screen (not shown), for example. On the display screen shown in FIG. 13A, a meal date column, a meal category column, a column for selecting “take no meal”, a meal memo entry box, a “select meal image” button, a “conform meal registration” button, and a “change password” button are displayed.

When information related to the date (meal date information) is inputted to the above-mentioned meal date column, and the “select meal image” button is operated, a plurality of images picked up on that day are thumbnailed and displayed, as shown in FIG. 13B. Photographing time is appended to each of the images, and a check box is displayed on the left side thereof. Further, a scroll bar is displayed on the right side of the screen, and an OK button and a Cancel button are displayed on the lower side of the screen. The user X sees the thumbnailed images, to select three of the images per meal as images to be transmitted. The selection is made by assigning a “ [symbol] ” mark to the check box. Thereafter, when the OK button is operated, the screen shown in FIG. 13A appears again, to enter the contents of the meal on a meal memo. When the “transmit meal data” button is operated, the meal date information, a meal category, the selected plurality of meal images (with photographing time), and the contents of the meal memo are transmitted to the server 5. When no meal is taken, a “ [symbol] ” mark is assigned to the column for selecting “take no meal”, to operate the “transmit meal data” button. When no meal is left over, it can be easily known that no meal is left over on the side of a nutritionist Z, described later, if the two images are sent. By such processing, the user X himself or herself is freed from calculating the calories of a taken meal.

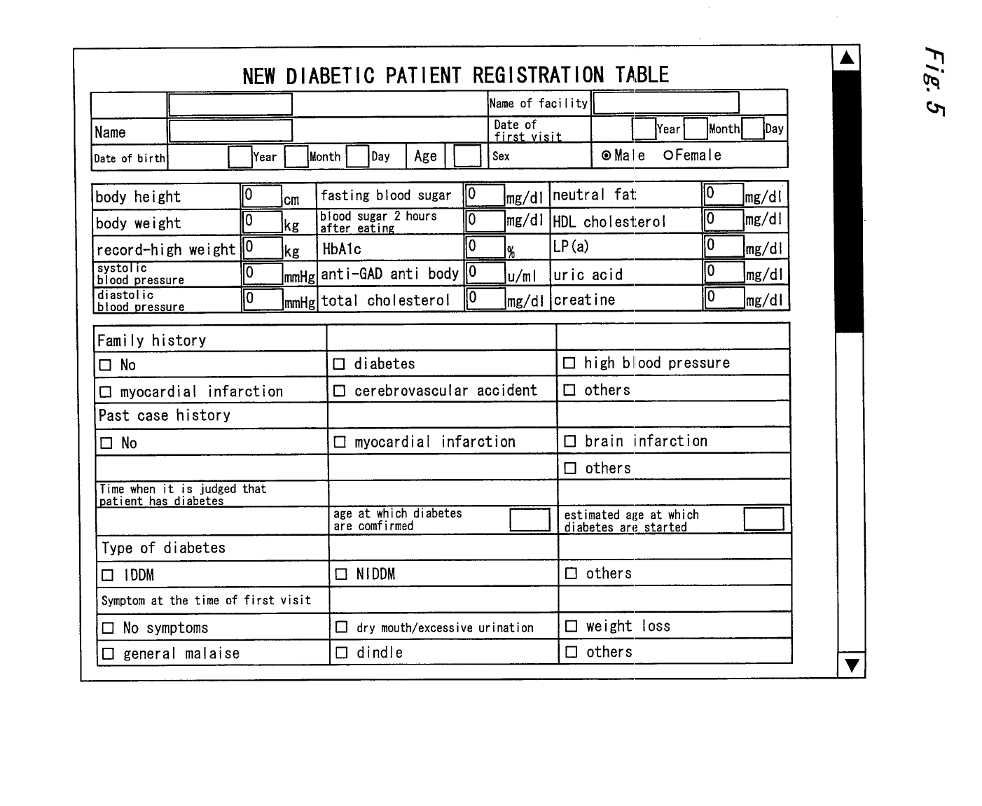

The server 5 stores user health related information constructed by managing for each user data related to answers to doctor's questions and the vital data which are transmitted from the pet terminal 1, and produces an HTML (Hypertext Markup Language) file, for example, having the user health related information as contents. In applying for registration of the user X (e.g., the first hospital visit), information related to the characteristics of a patient (address, name, birth date, body height, body weight, blood type, eyesight, etc.), diseases (case history, family history, etc.), a lifestyle (average working hours per day, average sleeping hours, etc.), meals (the number of meals per day, the number of between-meal snacks, the amount of alcohol, the frequency of eating-out, etc.), the contents of medical treatment (diet therapy (designated calories), exercise therapy (designated exercise), insulin administration, etc.) are initially registered. The user health related information are stored in relation to the data initially registered for each user. FIG. 5 illustrates an example of a screen indicating the registration of initial data. The initial registration can be performed using the doctor terminal 6.

The server 5 stores the text data (a meal memo) and data representing the meal image (meal image data) which have been sent from the PDA with a camera 4. The meal image data, for example, is transmitted to the nutritionist terminal 7 by a transmission request from the nutritionist terminal 7. The data may be transmitted as an image file attached to an e-mail to the nutritionist terminal 7. The nutritionist Z displays the meal image or the like using the nutritionist terminal 7. At this time, three meal images per meal are basically fed to the nutritionist terminal 7. Accordingly, the nutritionist Z can calculate calories taken in by the user X by seeing the three meal images. The three meal images are the whole meal image, an image of an accompanying dish to be a main dish, and an image of a left-over meal, as described above, per meal. Accordingly, the nutritionist Z performs calorie calculation more accurately, as compared with that based on only the whole meal image. Moreover, if data representing the meal memo (meal memo data) is added, the contents of Tempera, for example, can be known, thereby making it possible to more accurately perform calorie calculation.

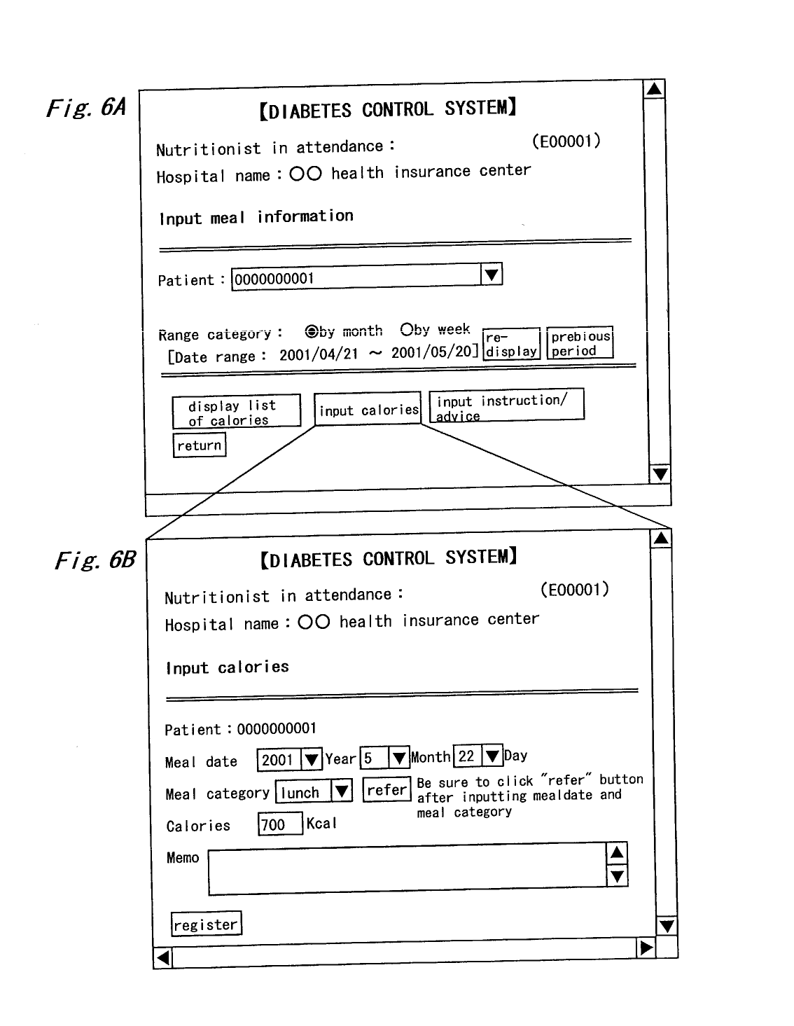

The nutritionist Z transmits the results of the calorie calculation as calories taken in by the user X to the server 5 using the nutritionist terminal 7. FIGS. 6A and 6B illustrate one example of an operation screen and a calorie calculation result input screen at the nutritionist terminal 7.

The server 5 performs processing for incorporating the results of the calorie calculation received from the nutritionist terminal 7 into the user health related information. Herein, the server 5 receives the meal date information, the meal category, the photographing time, and the contents of the meal memo together with the meal image data from the user X. The server 5 estimates the meal date on the basis of the meal date information and the photographing time. If the meal date information is Aug. 30, 2001, and the photographing time is 18:00, for example, the meal date can be estimated as 18:00 to 18:30 on Aug. 30, 2001. By performing such processing, the user X himself or herself is freed from time and labor to input and transmit the meal date.

Although the server 5 receives the vital data from the pet terminal 1, the type of data representing a blood sugar level (blood sugar level data) is estimated on the basis of the above-mentioned photographing time and information related to acquisition time (acquisition time information) in the blood sugar level data out of the vital data. For example, the blood sugar level data is estimated as a blood sugar level before dinner if the photographing time is 18:00, and the acquisition time in the blood sugar level data is 17:30, while being estimated as a blood sugar level after dinner if it is 19:00. Consequently, the user X himself or herself is freed from time and labor to input and transmit the type “blood sugar level after dinner”.

The server 5 transmits to the doctor terminal 6 the user health related information depending on the request from the doctor terminal 6. The doctor terminal 6 is operated by a doctor Y in attendance in a hospital which the user X attends.

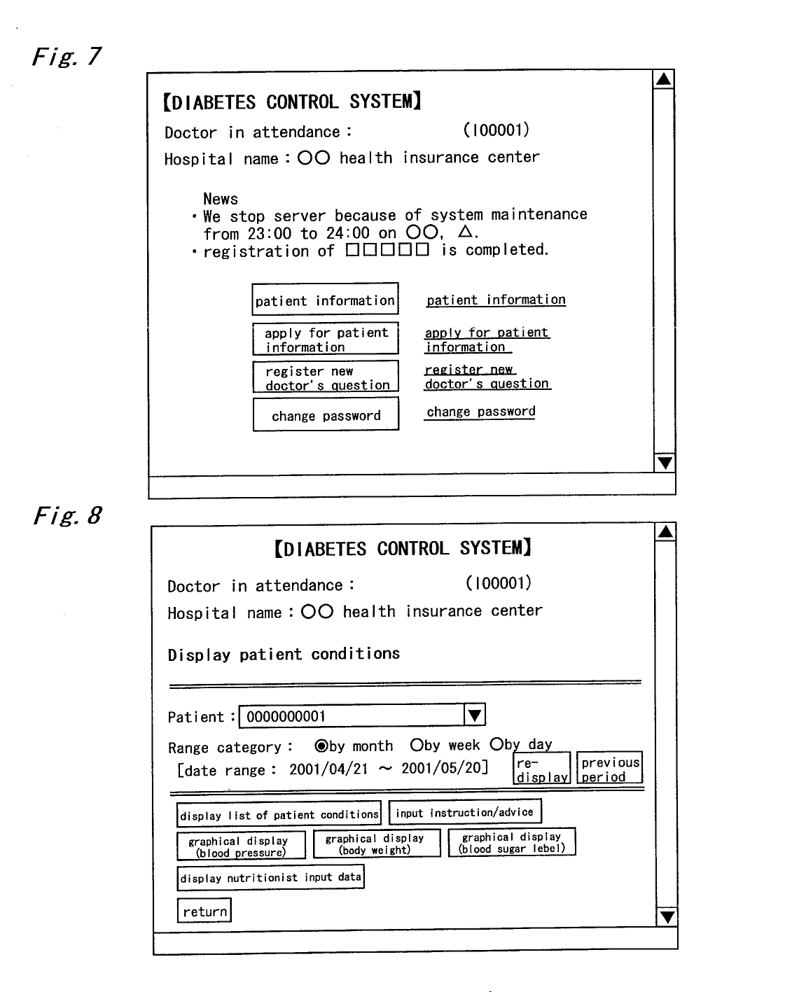

FIG. 7 is an explanatory view showing an example of an operation screen in the doctor terminal 6. In order to display the main menu screen, it is necessary to make Net connection to the server 5 and input a password. Buttons “patient information”, “apply for patient registration”, “register new doctor's question”, and “change password” are displayed on the main menu screen. When the buttons are clicked, the screen transition occurs.

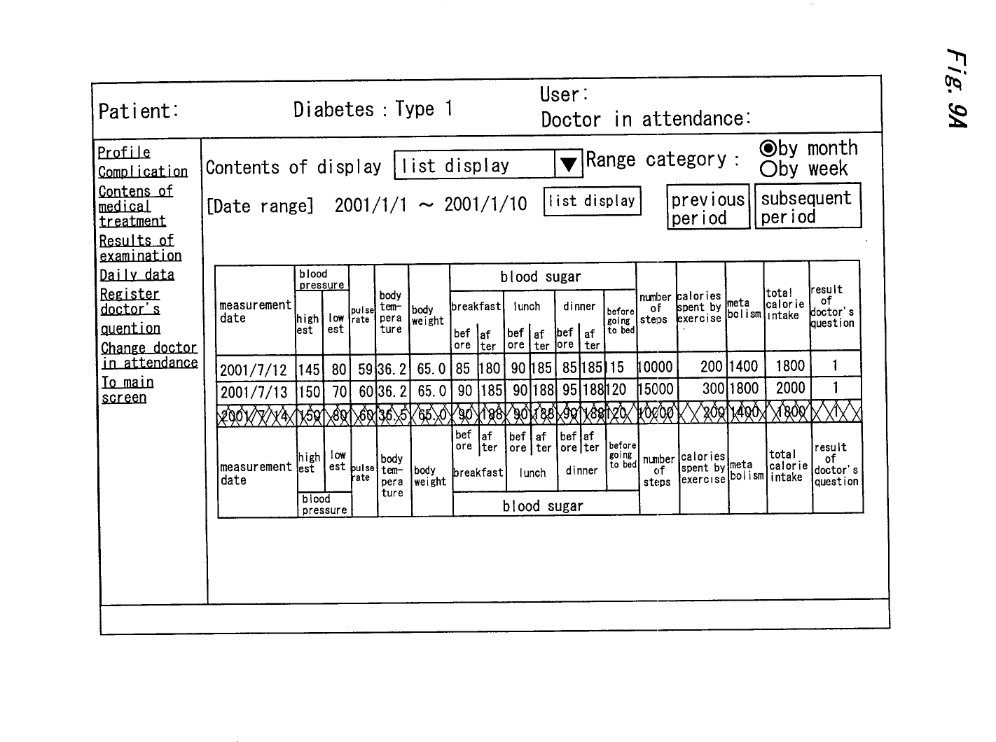

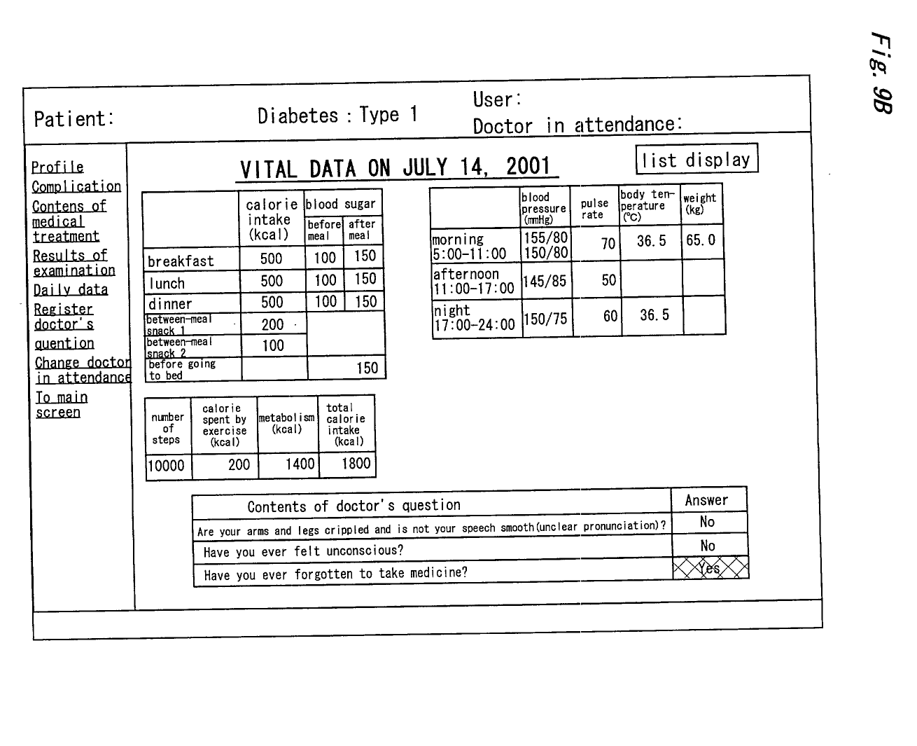

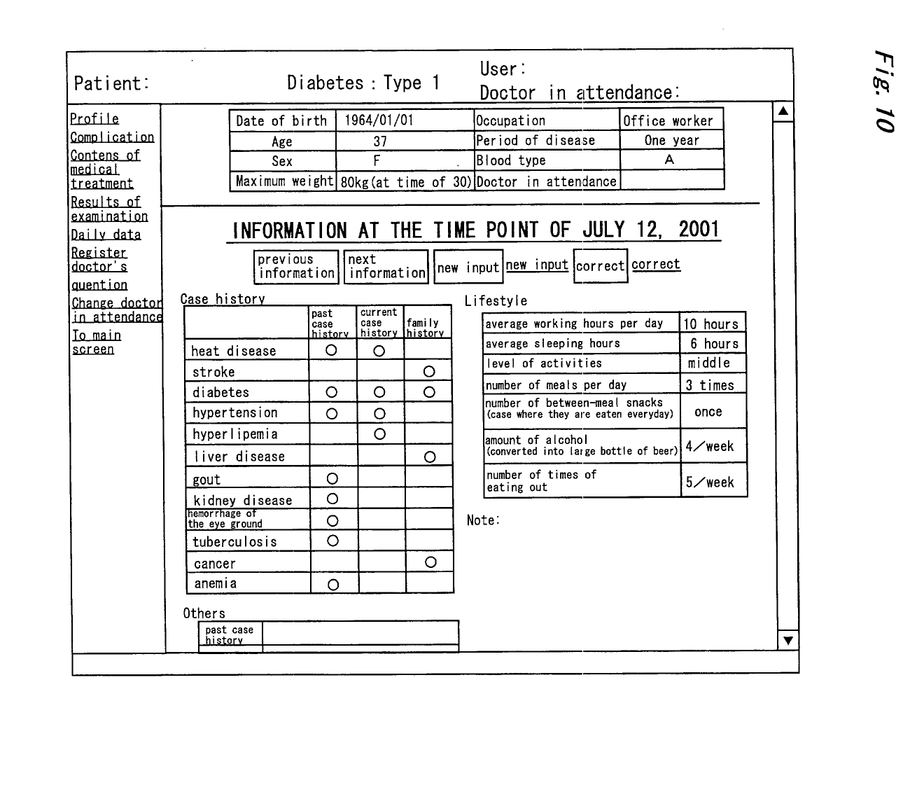

FIG. 8 is an explanatory view showing an example of a screen indicating patient information. A box of an item “patient” is operated on the screen, thereby making it possible to display a list of patient names and designate a desired patient. When an item “display of list of patient conditions” is clicked, a screen indicating data related to the designated patient (a screen indicating health related information (doctor's question result data, vital data, a calorie intake) is displayed, as shown in FIG. 9A. Further, when a desired date portion is clicked in a measurement date column on the screen, detailed data on the date is displayed, as shown in FIG. 9B. In the display of the detailed data, the relationship between calories taken in in each of the morning, afternoon, and evening and a blood sugar level is shown, the blood pressure or the like is categorized into those in the morning, afternoon, and evening, and a correspondence is shown with respect to the contents of each of doctor's questions and an answer to the doctor's question. In FIG. 9A, the result of the doctor's question “1” means that there is one answer requiring attention. In FIG. 9B, it can be known which of the doctor's questions is answered with an answer requiring attention.

FIG. 10 illustrates a screen indicating the profile of a patient. The screen is displayed by clicking the portion of “profile” in a column on the left side of the patient data screen shown in FIG. 9A. On the profile screen shown in FIG. 10, the contents of the data initially registered, described above, together with information related to the date of the registration, are displayed. However, the contents can be changed by correction, updating, or the like. When the contents are thus changed, the changed date is registered.

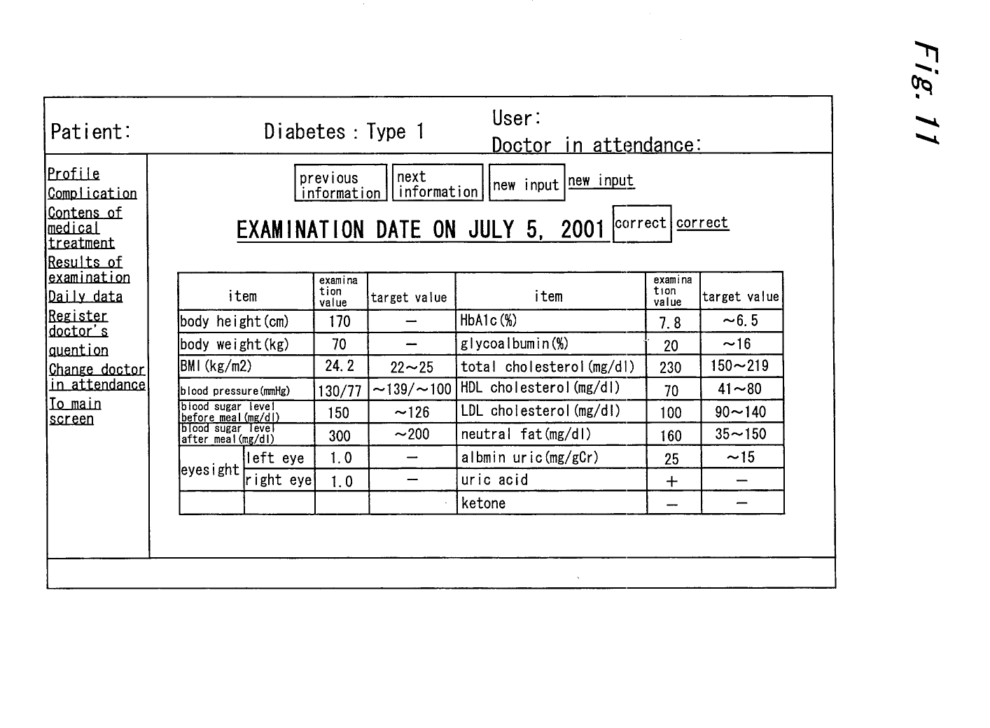

FIG. 11 illustrates a screen indicating information related to medical treatment given a patient (patient medical treatment information). The screen is displayed by clicking the portion of “results of examination” in the column on the left side of the patient data screen shown in FIG. 9A. On the examination result screen shown in FIG. 11, the results of the examination given when a user attends a hospital and the date of the examination are displayed. The results of the examination at the time of the hospital visit are also related for each user and stored in the server 5 as the above-mentioned user health related information.

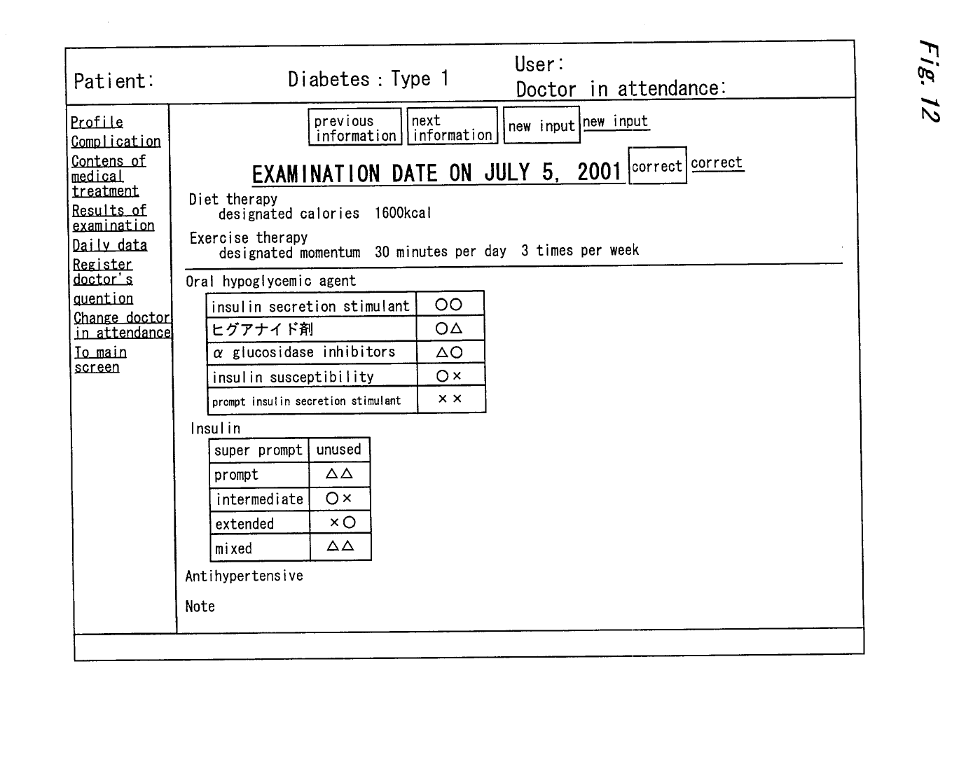

FIG. 12 illustrates a screen indicating patient medical treatment information. The screen is displayed by clicking the portion of “contents of medical treatment” in the column on the left side of the patient data screen shown in FIG. 9A. On the medical treatment content screen shown in FIG. 12, the contents of medical treatment given when a user attends a hospital and the date of registration are displayed. The contents of the medical treatment at the time of the hospital visit are also related for each user and stored in the server 5 as the above-mentioned user health related information.

The doctor Y in attendance connects, when the user X attends a hospital, to the server 5 using the doctor terminal 6, and sees the above-mentioned screen, thereby making it possible to refer to and use daily data for medical care.

In the specification, medical experts include a health care worker and a health care support enterpriser who manages health information related to a user to advise the user, performs a nursing procedure, and provides the health information to the health care worker. The network is not limited to one via a so-called provider, and includes one in a form directly connected to a server by a telephone line (a public line, a dedicated line, etc.). Further, the pet terminal 1 or PDA 4 may receive time information when it is connected to the server, for example, and establish communication between the pet terminal 1 and the PDA 4 to share the time information so that the server, the pet terminal 1, an the PDA 4 tick the same time. In estimating the time when the user takes a meal from data representing the time when the meal image is photographed by the PDA 4 and estimating the type of the blood sugar level data based on the time when the blood sugar level data is acquired, therefore, the reliability thereof can be increased.

As described in the foregoing, the user may photograph the contents of a taken meal at the portable information terminal with a camera and transmit data representing an image of the meal (meal image data) to the server. Accordingly, the user himself or herself is freed from time and labor to calculate the calories of the taken meal. A plurality of meal images (the whole image before a meal, an image of a left-over meal, etc.) are sent per meal, whereby the expert related to nutrition can perform calorie calculation more accurately than that in a case where the expert related to nutrition judges calories from one meal image. The medical expert can access the server in a medical-side information processor, and read the calorie intake information as one of user health related information constructed by managing data for each user. When the user visits the medical expert, daily calorie intake information related to the user can be seen in the medical-side information processor, thereby making it possible to efficiently provide medical care.

If the server is so configured as to estimate the time when the user takes a meal using the photographing time information added to the meal image data, the user himself or herself is freed from time and labor to input and transmit the meal time. If the server is so configured as to estimate, in a case where the photographing time information is added to the meal image data, the type of blood sugar level data on the basis of the photographing time information and acquisition time information in the blood sugar level data, the user himself or herself is freed from time and labor to input and transmit the type “blood sugar level after lunch”.

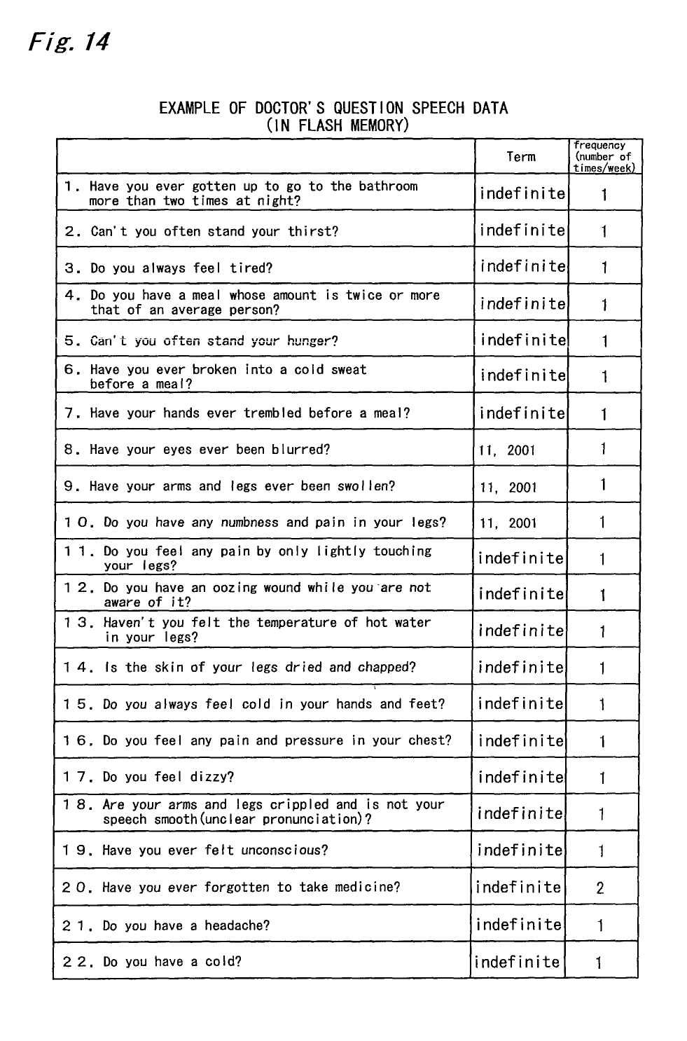

FIG. 14 shows the contents of doctor's questions and management information related thereto. General doctor's questions from Number 1 to Number 20 shall be fixedly held at the pet terminal 1. The doctor's questions from Number 21 to Number 22 are added doctor's questions received from the server 5. Term information and frequency information are added to each of the doctor's questions. The pet terminal 1 asks all the doctor's questions from Number 1 to Number 22 in a cycle of one week the several questions at a time, excluding the out-of-date questions on the basis of the current date information received from the calendar functional unit 107 and further considering the frequency information. As the above-mentioned frequency information, such setting that “7” is asked four times per year, “6” is asked once per month, “4” is asked once per week, “2” is asked once per day, and “1” is asked three times per day can be employed.

The fixed contents of the doctor's questions are stored as speech data in the flash memory 111. The added questions may be received by the text data from the server 5, and synthesized and outputted as speech on the side of the-pet terminal 1. Alternatively, the server 5 may perform speech synthesis processing on the basis of the text data to produce speech data (a speech file) and feeds the speech data to the pet terminal 1.

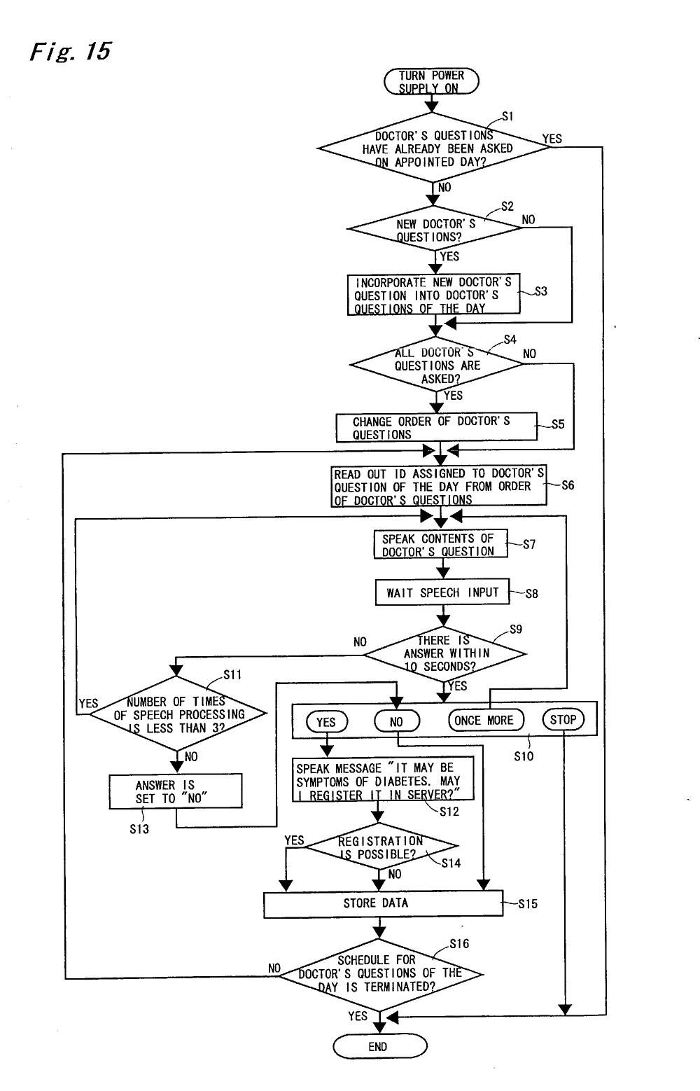

An example of a rule of doctor's questions set at the pet terminal 1 in the present embodiment will be described while referring to a flow chart of FIG. 15.

(1) Number of Doctor's Questions and Frequency Thereof

To ask three to four doctor's questions in one day and ask all the doctor's questions in one week is taken as a basis. Ones, excluding the out-of-date doctor's questions and the doctor's question which are set not to be used, of the registered doctor's questions are doctor's questions to be used. The number of doctor's questions asked for each day is determined depending on the number of doctor's questions to be used. When the number of doctor's questions to be used is 23, the number of doctor's questions asked in days of one week is 4, 4, 3, 3, 3, 3, and 3.

(2) Order of Doctor's Questions (Step S5)

The order in which the doctor's questions are spoken is random. In this case, the same doctor's question is prevented from being asked continuously two times or for two days.

It is assumed that there are 20 doctor's questions “1, 2, 3, 4, 5, 6, 7, 8, 9, 10, 11, 12, 13, 14, 15, 16, 17, 18, 19, and 20 (Initial rotation. A numeral denotes an ID assigned to a doctor's question), for example. Herein, when processing for rearranging the doctor's questions excluding the last four doctor's questions at random is performed, the results are “10, 16, 12, 14, 5, 2, 13, 7, 15, 4, 6, 8, 11, 3, 9, 1, 17, 18, 19, 20”, for example (e.g., the first four doctor's questions are outputted on the first day). When processing for rearranging the doctor's questions excluding the first four doctor's questions is further performed, the results are “10, 16, 12, 14, 20, 19, 9, 2, 7, 4, 1, 15, 5, 11, 18, 13, 6, 8, 17, 3”, for example (e.g., the fifth to eighth doctor's questions are outputted on the second day).

(3) Case Where There is Day on Which No Doctor's Questions are Asked

If there is a day on which the pet terminal 1 is not operated, the prepared doctor's questions are asked on the next day and the subsequent days. When the doctor's questions are started, a new rotation is set at the time point where it is found that the previous rotation is terminated.

(4) Case Where Doctor's Question is Added

A doctor's question newly added (received) (YES in step S2) is added to a list in determining the order, so that it is asked at the time of asking the first of the subsequent doctor's questions (step S3). An ID assigned to the added doctor's question and the term thereof, text data related to the added doctor's question, etc. are received from the server 5.

(5) Case Where There is Out-of-Date Doctor's Question

The out-of-date doctor's question is excluded from the list on the day on which the order is determined.

(6) Data Management at Pet Terminal 1

The dates of doctor's questions, IDs assigned to the doctor's questions, and answers corresponding to past one week are saved in the memory 105 of the pet terminal 1. It can be judged whether or not doctor's questions have already been asked on the appointed day depending on whether or not the newest one of the days on which the past answers are made, which are saved in the memory 105 of the pet terminal 1, coincides with the current date (given from the calendar functional unit 107) (step S1).

(7) As to Operation of Doctor's Questions

Doctor's questions are started when the pet terminal 1 is turned on, for example, a greeting “hello” is spoken, if the time is the daytime, for example, in conformity to the time when the pet terminal 1 is turned on, a simple conversation “How are you?” is further carried on, and words of the doctor's questions are then successively spoken from the list of doctor's questions of that day (step S6, step S7).

A waiting time period required for a user to make an answer “YES” or “NO” is taken as 10 seconds (a time-out for a routine of speech recognition is taken as 10 seconds). When there is no answer after an elapse of 10 seconds (NO in step S9), words are spoken once again (step S11, step S7, step S8, and step S9). This processing shall be performed three times. When there is no speech input if the processing is performed three times, the answer is “NO” (step S13). When there is an answer by the foot switch 104, no words are spoken again. When the answer is “YES” (“YES” in step S10), a question “It may be a symptom of diabetes. May I register it in a server?” (which is a notification corresponding to an answer requiring attention) is asked (step S12). If the answer is “YES”, processing is performed as “possible registration” (YES in step S14), and information “possible registration in server” is stored in the step S15. In the other answers, processing is performed as “impossible registration” (NO in step S14), and information “impossible registration in server” is stored in the step S15.

Assuming a case where the contents of the doctor's question cannot be caught, a keyword “once again” is spoken again (“once again” in step S10). When there is no answer even by speaking the words again, a guide “Please say “YES” toward the pet if the answer is “YES”, and say “NO” toward the pet if the answer is “NO”” is spoken. If no answer is obtained, words “Do you stop doctor's questions?” are spoken. If the answer “YES” is obtained (“Stop” in step S10), a doctor's question task is terminated, after which the program proceeds to a routine related to vital data acquisition, for example. If the answer is “NO”, the same item of doctor's questions is spoken again. It is judged whether or not the schedule of the doctor's questions of the day is terminated (step S16). If the schedule is terminated, the doctor's question task is terminated. If it is not terminated, the program proceeds to the step S6.

The pet terminal 1 is caused to have a function capable of confirming the contents of answers to the doctor's questions of the day. If the user is not satisfied with the contents (someone of a user's family asks doctor's questions without permission, for example), the doctor's questions can be asked again.

Data for Doctor's Questions

IDs assigned to doctor's questions: two bytes. 1 to 20 are assigned to default doctor's questions. Doctor's questions prepared by a doctor are assigned 21 and the subsequent numbers. An ID assigned to a doctor's question to be newly added is added by the server.

Contents of doctor's questions: default doctor's questions (the fixed contents of doctor's questions) are taken as speech compressed data. An arrangement of the numbers of the speech compressed data respectively corresponding to the IDs assigned to the doctor's questions is prepared (a plurality of speech compressed data may be used with respect to one ID). With respect to the doctor's question added from the server 5, the ID and text data are received from the server 5.

Management of history: an ID assigned to a doctor's question, the date on which the doctor's question is answered, and the contents of an answer to the doctor's question are saved in the memory 105 (corresponding to past three days).

Transmission of results: an ID assigned to a doctor's question, the date on which the doctor's question is asked, and the contents of an answer (YES/NO) to the doctor's question are transmitted to the server

Download from server 5: an ID assigned to a doctor's question, text (or speech compressed data), and a term (YYYYMMDD) shall be downloaded.

The others: the number of default doctor's questions, the number of added doctor's questions, the current group and order (for the next day and the subsequent days), the number of doctor's questions asked on each day, and so forth are considered.

Furthermore, the MPU 101 obtains the current date information from the calendar functional unit 107, to turn the timer on when it is 0:00 a.m. every day, for example, gives a start command to the PHS wireless communication unit 106, and automatically makes wireless Internet connection. Vital data, data representing the results of doctor's questions, etc. which have been so far acquired are read out of the memory 105, and are transmitted to the server 5 through the PHS wireless communication unit 106. At this time, if added doctor's question data addressed to the user himself or herself exists in the server 5, processing for receiving the added doctor's question data is performed.

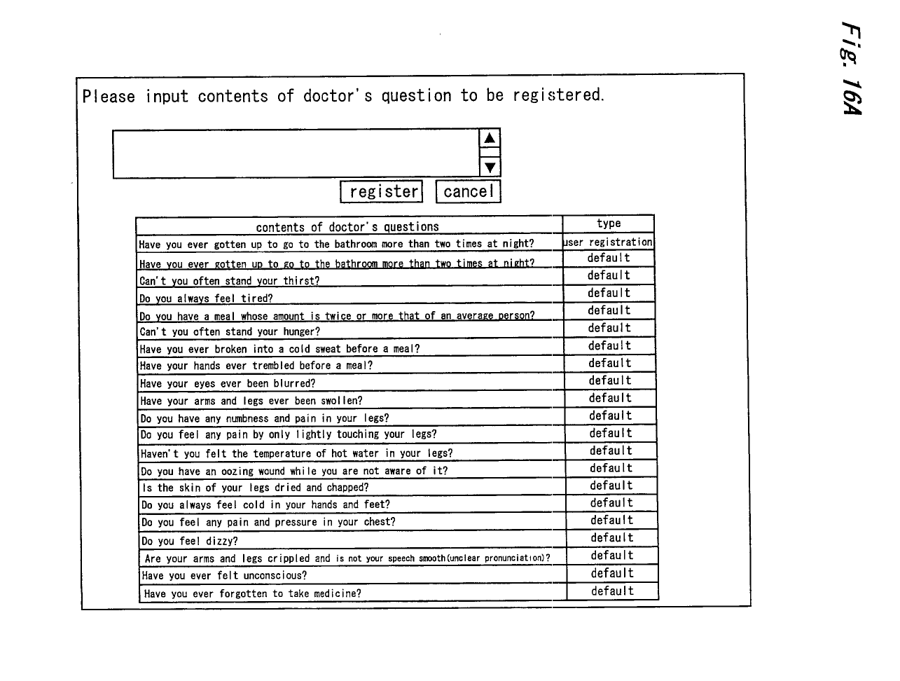

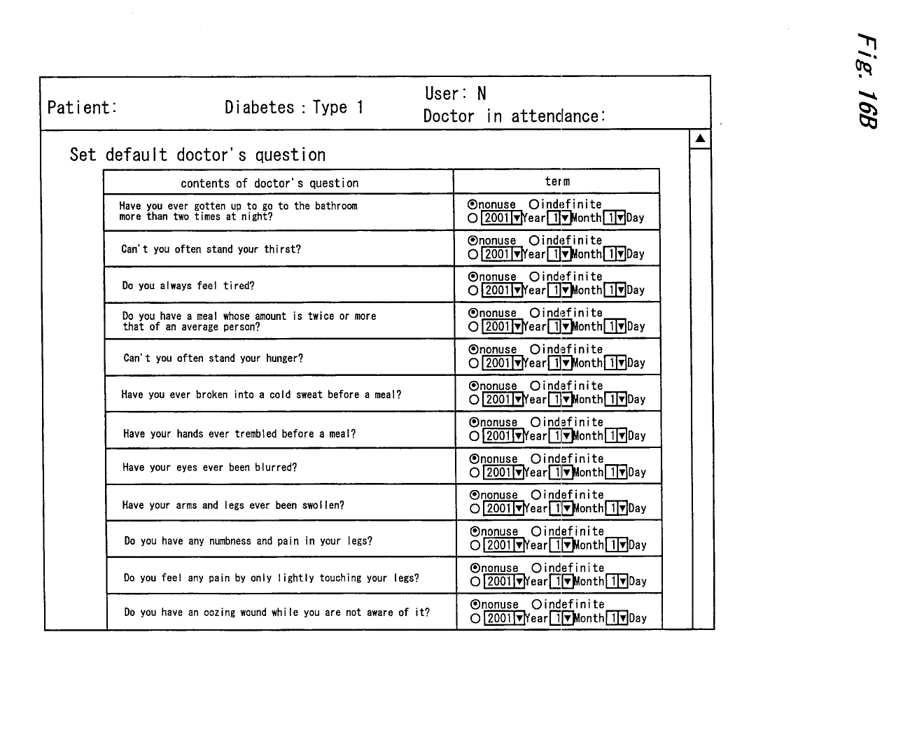

FIGS. 16A and 16B illustrate an example of a screen indicating the contents of questions set for the user X. The screen is displayed at the doctor terminal 6, and the data are received from the server 5. When the doctor Y desires to ask the user X an added question by seeing the screen shown in FIG. 16A, the doctor Y may enter the contents of the question into a text box and transmit the contents to the server 5. Further, the doctor Y can perform nonuse setting or term setting for the contents of each of the doctor's questions to transmit them to the server 5 by seeing the screen shown in FIG. 16B. The server 5 stores the contents of the questions for each user, and transmits the above-mentioned setting information and the added question when it is connected to the pet terminal 1.

As described in the foregoing, the user can enjoyably come in contact with the health care support terminal by questions asked by speech output from the terminal. Accordingly, the vital data is easy to continuously acquire, and the ratio of the number of answers to the number of questions is also increased. The vital data and the answer data which have been acquired are automatically transmitted. Accordingly, it does not take the user time and labor to transmit data. At the health care support terminal, questions fixedly stored previously exist. Accordingly, the frequency of the transmission of question data from the server to the health care support terminal can be reduced. A medical expert can access the server in the medical-side information processor, and register in the server an added question and setting information such as frequency information to the user. Further, the medical expert can read the answer data as user health related information constructed by managing data for each user by accessing the server. When the user visits the medical expert, answers to the questions, which have already been asked, can be seen in the medical-side information processor even if the questions are asked then and there, thereby making it possible to effectively provide medical care. Further, in the pet-type health care support terminal having a imitative biological form, an affinity with the user is increased because of the form. Data transmission is made by wireless Net connection, so that the health care support terminal can be carried about and put in a favorable place. The questions fixedly held at the pet-type health care support terminal are given to the user at random, thereby making it possible to prevent the user from being tired of the questions by repeating the questions in the same rotation. If there occurs no overlapping (e.g., the same questions continuously two times or continuously for two days) in outputting the questions at random, it is possible to prevent such user's discomfort that the questions were answered earlier or were answered yesterday.

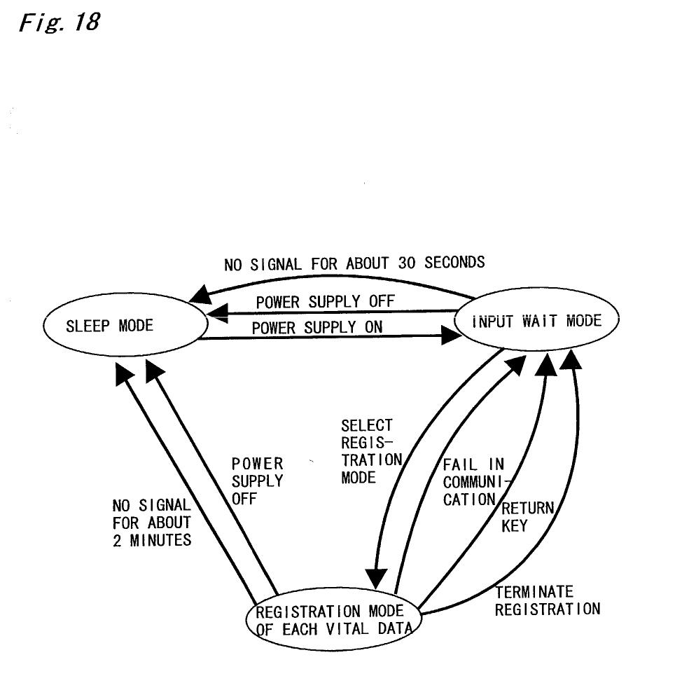

FIG. 18 is a state transition diagram in processing of a communication adaptor combined with a remote control 2. The state transition occurs among a sleep mode, an input wait mode, and a vital data registration mode.

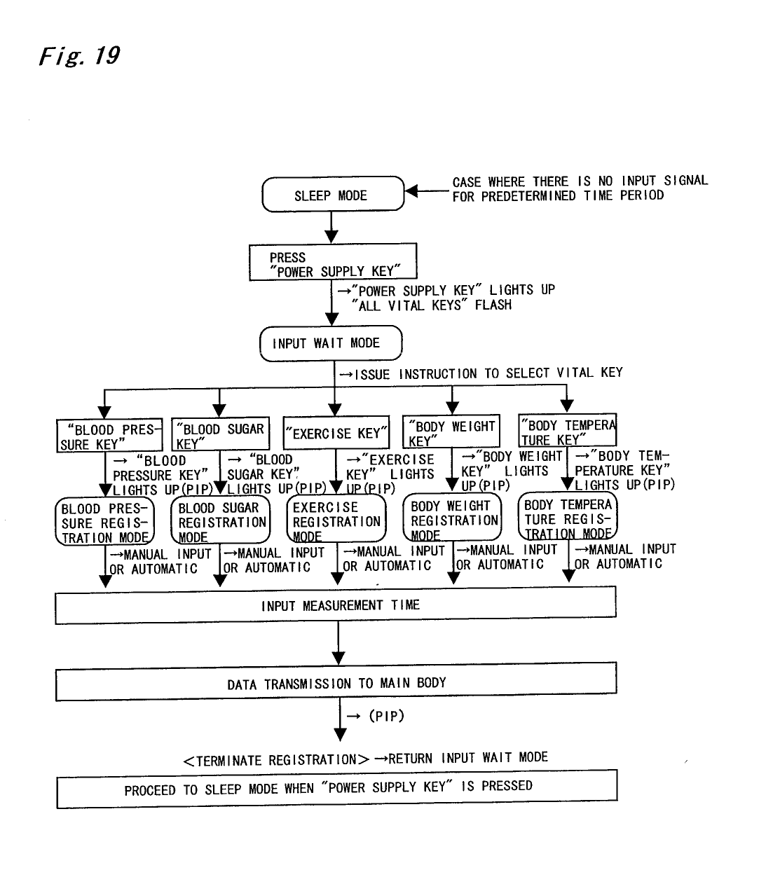

FIG. 19 is a flow chart simply showing data transmission processing from vital data input processing by the communication adaptor combined with a remote control 2 to the pet terminal 1 while adding the relationship with the state transition.

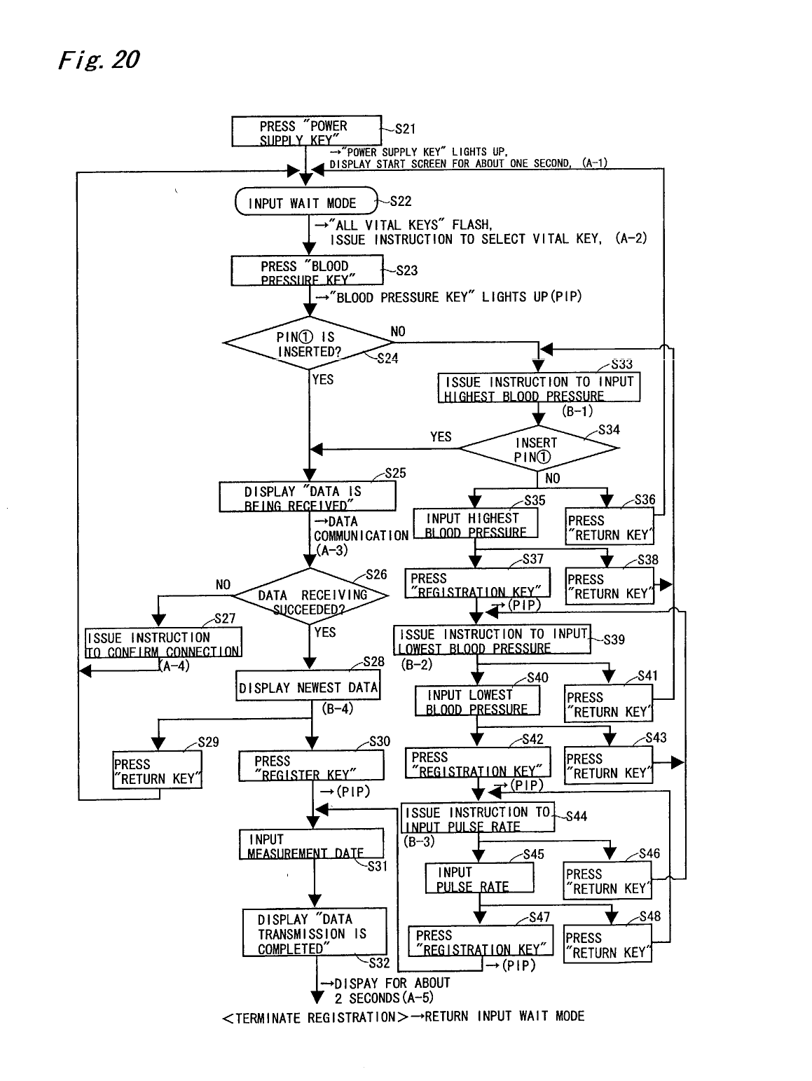

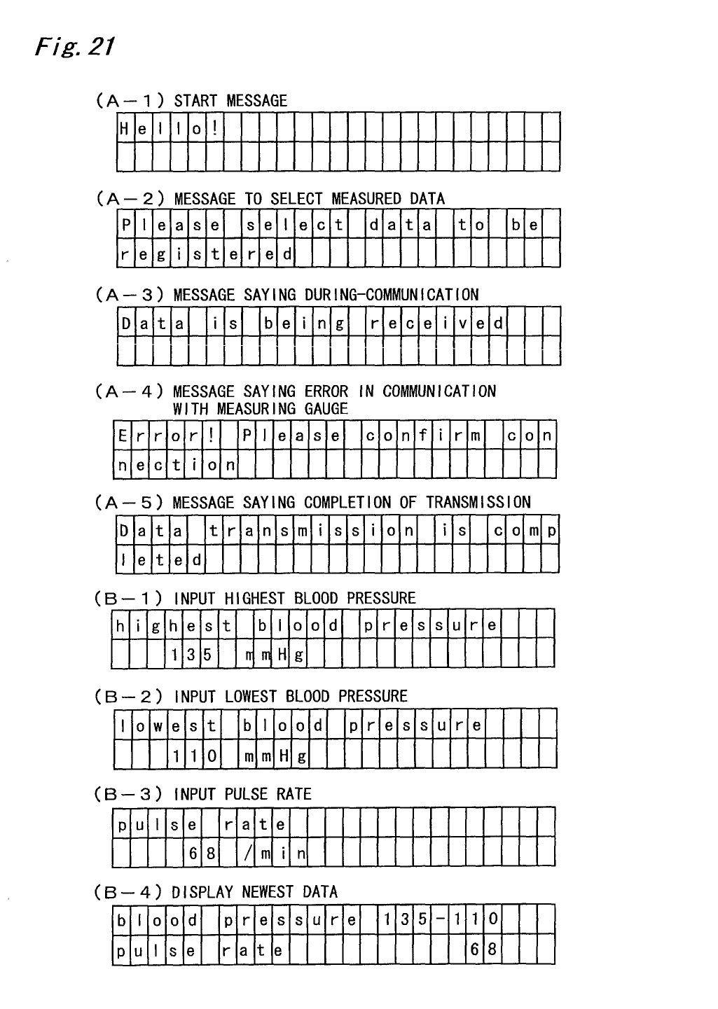

Blood pressure data acquisition processing in the processing shown in FIG. 19 will be described using a flow chart of FIG. 20. FIG. 21 illustrates a message displayed on a liquid crystal display screen LCD of the communication adaptor combined with a remote control 2. When the user presses a “power supply key” in the communication adaptor combined with a remote control 2 (step S21), the program proceeds to the input wait mode (step S22). At this time, a message “hello!” is displayed on the LCD as a start message (see FIG. 21(A-1)). In the input wait mode, all vital keys (a blood pressure key, a blood sugar key, etc.) flash. After the start message (displayed for approximately one second), a message “Please select data to be registered” is displayed as a message to select measured data, to prompt the user to select the vital key (see FIG. 21(A-2)). When the user presses the “blood pressure key” (step S23), the “blood pressure key” lights up, to produce a sound “pip”.

It is then judged whether or not a pin is inserted into a data communication terminal \mathring{1} (step S24). When the pin is inserted therein, a message saying during-communication “Data is being received” is displayed on the LCD (step S25: see FIG. 21(A-3)), to perform data receiving processing. It is judged whether or not data receiving succeeded (step S26). When the data receiving does not succeed, a message “Error! Please confirm connection” is displayed as a message saying an error in communication with a measuring gauge (see FIG. 21(A-4)), to issue an instruction to confirm connection (step S27), after which the program proceeds to the input wait mode. When the data receiving succeeded (YES in step S26), newest data, for example, “blood pressure 135-110 and pulse rate 68”, is displayed (step S28: see FIG. 21(B-4)

When the user presses a “return key (back key)” (step S29), the program proceeds to an input wait mode. When the “register key” is pressed (step S30), a sound “pip” is produced. After the measurement date is inputted by the user (step S31), a message “Data transmission is completed” is displayed for approximately two seconds as a message saying completion of transmission (step S32 see FIG. 21(A-5)). The registration processing is terminated, after which the program is returned to the input wait mode.

When no pin is inserted into the data communication terminal \mathring{1} (No in step S24), “highest blood pressure □□□ mmHg” is displayed on the LCD as a message for prompting the highest blood pressure to be manually inputted (step S33: see FIG. 21(B-1)). Thereafter, it is confirmed again whether or not a pin is inserted (step S34). If the pin is inserted, the program proceeds to the step S5. When no pin is inserted, the user uses a numeric key in the communication adaptor combined with a remote control 2, to manually input the highest blood pressure (step S35: see FIG. 21(B-1)), and presses the “register key” (step S37). When the “register key” is pressed, a sound “pip” is produced. Further, the user is prompted to manually input the lowest blood pressure (steps S39, S40, and S42) and manually input the pulse rate (step S44, S45, and S47) in the same procedure as that in a case where the highest blood pressure is manually inputted, to register the lowest blood pressure and the pulse rate. When the “return key” is pressed in each processing (steps S36, S38, S41, S43, S46, and S48), the program is returned to the processing in the preceding stage.

Although in the above-mentioned example of processing, the blood pressure level is registered, the same processing is also performed with respect to the registration of the blood sugar level and the amount of exercise. With respect to the blood sugar level, there is processing for prompting the user to select a meal (breakfast, lunch, etc.) and to select before eating or after eating.

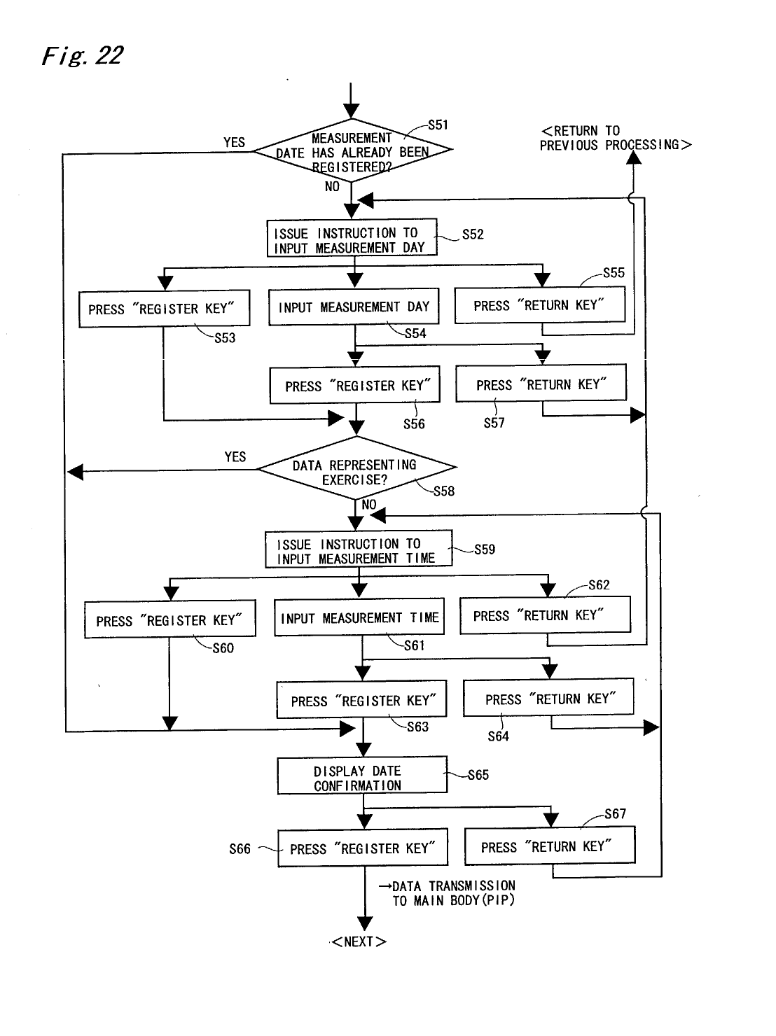

FIG. 22 is a flow chart showing processing for registering the measurement date in the step S31 shown in FIG. 20. It is first judged whether or not the measurement date has already been registered (step S51) When the measurement date has not been registered yet, the measurement date is prompted to be inputted (step S52). When the user presses the “register key” as it is (step S53), the program proceeds to the step S58. When the user inputs the measurement date (step S54), the user presses the “register key” after the input (step S56).

When the vital data is the amount of exercise (YES in step S58), the time need not be inputted. Therefore, the program proceeds to date confirmation display processing (step S65). In cases other than the registration processing of the amount of exercise, the measurement time is prompted to be inputted (step S59) When the “register key” is pressed as it is (step S60) the program proceeds to the date confirmation display processing (step S65). When the user inputs the measurement time (step S61), the user presses the “register key” after the input (step S63). Thereafter, display for confirming the date is performed (step S65). When the “register key” is pressed (step S66), data is transmitted to the pet terminal 1 by infrared transmission, to produce a sound “pip”. When the “return key” is pressed in each processing (steps S55, S57, S62, S64, and S67), the program is returned to the processing in the preceding stage.

When the “register key” is pressed without inputting the date (steps S53 and S60), the current date information acquired from the calendar functional unit 107 is employed on the side of the pet terminal 1, and is added to vital data.

The communication adaptor combined with a remote control 2 is provided with a button meaning emergency, to transmit by wireless (e.g., by infrared rays) the information meaning emergency to the pet terminal 1 when the button is operated. The pet terminal 1 makes Net connection to the server 5, or makes emergency data transmission (transmission of user specification information for emergency, etc.) in the PHS wireless communication unit 106 to a center for emergency, for example, when it receives the information meaning emergency transmitted by wireless from the communication adaptor combined with a remote control 2. Consequently, a predetermined measure is taken by knowing the emergency of the user on the side of the server 5 or in the center for emergency.

Furthermore, the communication adaptor combined with a remote control 2 is provided with a button meaning consultation, to transmit by wireless (e.g., infrared rays) information meaning consultation to the pet terminal 1 when the button is operated. The pet terminal 1 makes line connection in the PHS wireless communication unit 106 to a center for consultation, for example, when it receives the information meaning consultation transmitted by wireless from the communication adaptor combined with a remote control 2. Consequently, the user can consult with an operator in the center for consultation by phone through the pet terminal 1.

Furthermore, the pet terminal 1 notifies, when there is vital data which is scheduled to be acquired and has not been acquired yet, the user of the vital data by speech output. For example, “Do you measure vital?” is spoken after simple conversation processing. When the user X answers “NO”, “All right. All data for today are registered.” is spoken if all data for the day are acquired. On the other hand, if blood sugar level data are insufficient, “The blood sugar level has not been measured yet today. Do you measure it?” is spoken by way example. The wireless transmission is simultaneously performed by both infrared rays and radio waves in the communication adaptor combined with a remote control 2. In the vital data acquisition Net transmission system, it is desirable in making transmission/receiving of information reliable that both infrared rays and radio waves are simultaneously received.

As described in the foregoing, the vital data is received from a vital measurement device such as a blood pressure gauge, a blood sugar gauge, or a exercise gauge by the vital data acquisition device, and the vital data is transmitted by infrared rays to the pet-type health care support terminal, for example. Therefore, several effects are produced. For example, a data acquisition operation can be more easily performed using a general blood pressure gauge or the like, as compared with that in a case where the pet-type health care support terminal itself has a vital measurement device. Further, with respect to the health care support terminal, healing processing such as the function of a conversation with a user is easily expanded.

Furthermore, the MPU 101 can judge the features of the user X by the above-mentioned conversation and doctor's questions. For example, when words “sweets” and “want to eat” are recognized in the conversation, or when the user makes a answer “YES” to “Do you have a strong desire to eat sweets?” as one of the doctor's questions, it is judged the feature that the user X likes sweets. Further, information related to the attributes of a user, such as sex and age, can be also previously registered in the memory 105 and taken as one of the user feature information.

The MPU 101 issues a start command to the PHS wireless communication unit 106 when it is recognized that the user X spoke words “Net”, for example, by a speech recognition function, and automatically carries out wireless Internet connection. Further, it can also issue a start command to the PHS wireless communication unit 106 when the switch 104 is operated, and automatically carry out Internet connection. When it is connected to a dedicated information site previously registered, for example, in the Internet connection, the user feature information is read out of the memory 105, and is fed to the information site. The information site may exist in the server 5. In the information site, an advertisement particularly useful for health, for example, “We suggest you ◯◯ sugar whose calories are cut for people who like sweets” is prepared in the form of text data and a speech file (a retrieving name, for example, “like sweets” is attached, for example, in the case of the speech file). If there are contents “like sweets” as the user feature information, the contents are used as a keyword to select the above-mentioned advertisement and transmit the advertisement to the pet terminal 1. When selection control information “for those who are 50 years old or older”, for example, may be added to the above-mentioned advertisement, to perform processing for selecting the above-mentioned advertisement when information “52 years old” as attribute information in the user feature information.

The pet terminal 1 can read, when it acquires the advertisement information, an advertisement using a speech output function (including a speech synthesis function) to output the advertisement information by speech from the speaker 110, or can perform, when the advertisement information is a speech file, processing for decoding the advertisement information and processing for changing the advertisement information into speech to output the advertisement information by speech from the speaker 110.

If a personal computer is provided in a user's home, an e-mail, for example, having advertisement information and home page URL data and other data obtained by retrieval using user feature information as a keyword, as described above, as contents (the mail address of the user may be previously registered) shall be produced on the side of the site, and the user X may receive the e-mail using the personal computer to obtain the information. It may be possible for the server 5 to make a graph, for example, of daily vital data related to the user X, and for the user X to see the graph using the above-mentioned personal computer.

The pet terminal 1 holds in the memory 105 information as to which of “YES” and “NO” is an answer requiring attention with respect to each of the contents of doctor's questions, and notifies, when the answer is an answer requiring attention, the user of the answer requiring attention. Further, it holds a value requiring attention with respect to one or a plurality of vital data, and notifies, when the vital data related to the user transmitted from the communication adaptor combined with a remote control 2 exceeds the value requiring attention, the user of the vital data. The notification can be outputted by speech, for example, “Take little care” using LED red lighting, speech synthesis, or the like (not shown).

Furthermore, the server 5 can transmit, at the time of Net connection from the pet terminal 1, for example, the results of calculation of calories of each meal or whole meals per day (e.g., numeric data and a speech file) to the pet terminal 1. The pet terminal 1 can perform processing for reading, when it receives the numeric data and the date data as the results of calculation of calories, for example, the data by speech synthesis, and report calories taken in to the user X by speech, for example, “Calories taken in yesterday are 3000 calories”.

As described in the foregoing, the user can enjoyably come in contact with the terminal by words and questions outputted by speech from the health care support terminal. Accordingly, the vital data is easy to continuously acquire, and the ratio of the number of answers to the number of questions is also increased. Since the vital data and the answer data which have been acquired are automatically transmitted, it does not take the user time and labor to transmit the data. The data transmission is made by wireless Net connection. Accordingly, the health care support terminal can be carried about and put in a favorable place. Further, in the pet-type health care support terminal having a imitative biological form, an affinity with the user is increased because of the form. In such a configuration that Net connection is automatically made when a user's Net connection request is issued by a speech recognition function and a switch provided at the foot or the like. Net connection by a user's intension can be made without comprising a keyboard, a mouse, and so forth. The user can recognize information obtained by the Net connection by speech. It is considered that a lot of aged people utilize the pet-type health care support terminal. The pet-type health care support terminal makes Net connection in place of Net connection by a personal computer which such aged people are not good at. Accordingly, an affinity with the pet-type health care support terminal is further increased, and the ratio of the number of answers to the number of questions is improved. Further, this can contribute toward continuously acquiring the vital data. In such a configuration that the user is notified, when the answer is an answer requiring attention, of the answer, the user can simply check his or her health. Further, the simple health check is obtained then and there, thereby making it possible to improve the ratio of the number of answers to the number of questions. In such a configuration that the user is notified, when vital data related to the user exceeds the value requiring attention, of the vital data, the simple health check is obtained then and there. Accordingly, this can contribute toward continuously acquiring the vital data. In such a configuration that Net retrieval is performed using user feature information as a key, the Net connection can be easily enjoyed in the pet-type health care support terminal having no keyboards, etc. Such a configuration that the user feature information is acquired from the contents of a conversation with the user or the contents of questions and answers using speech recognition and speech output becomes suitable in the pet-type health care support terminal having no keyboards, and so forth. A medical expert can access the server in the medical-side information processor, and read the vital data or the like as user health related information constructed by managing data for each user. When the user visits the medical expert, daily vital data or the like related to the user can be seen in the medical-side information processor, thereby making it possible to efficiently provide medical care. Further, in a system in which calorie intake information is incorporated into the server, the medical expert can access the server in the medical-side information processor, and also read the calorie intake information as the user health related information constructed by managing data for each user. When the user visits the medical expert, the calorie intake information related to the user can be seen in the medical-side information processor, thereby making it possible to efficiently provide medical care. Further, the calorie intake information registered in the server is transmitted to the health care support terminal placed on the side of the user. If the calories taken in are reported by speech at the health care support terminal, not only the medical expert but also the user can know the calories taken in without laborious calculation.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A health care support system, wherein
a medical-side information processor placed on the side of a medical expert and a health care support terminal placed on the side of a user are connected to a server through a network,
said health care support terminal comprising speech output means for outputting speech on the basis of speech synthesis or speech data, to ask the user a question fixedly stored previously and/or a question added by said server, acquire an answer to the question by information acquisition means for acquiring information returned from the user, and automatically transmit answer data representing the answer to said server, and
said server holding a list of questions for each user, transmitting data representing the added question to said health care support terminal, storing at least user health related information constructed by managing the answer data for each user, transmitting at least said user health related information to said medical-side information processor in response to a request from the information processor, and receiving the added question for each user inputted from said medical-side information processor.

2. The health care support system according to claim 1, wherein
the list of questions for each user from said server is received in said medical-side information processor, and
at least one of input of the term of the question, input of the frequency of the question, input of nonuse/use of the existing question, and input of the added question can be performed on the list of questions.

3. A pet-type health care support terminal having a imitative biological form, comprising:
speech output means for outputting speech on the basis of speech synthesis or speech data;
means for acquiring vital data related to a user directly or indirectly through auxiliary equipment;
storage means for fixedly holding a plurality of questions as well as holding, when an added question is received, the question;
means for asking the user a question using said speech output means, detecting information returned from the user, and acquiring an answer to the question;
means for randomizing the order of the questions fixedly stored; and
means for making automatic wireless Net connection to transmit and receive data to and from a server.

4. The pet-type health care support terminal according to claim 3, wherein
the held questions are outputted in several days such that they are not overlapped with one another.

5. The pet-type health care support terminal according to claim 3, wherein
in a case where the added question is received, the added question is outputted prior to the questions fixedly held.

6. The pet-type health care support terminal according to claim 3, wherein
judgment which of “YES” and “NO” is an answer requiring attention with respect to the contents of each of the questions is held, to notify, when the answer is the answer requiring attention, the user of the answer.

7. The health care support system according to claim 1, wherein
the health care support terminal is the pet-type health care support terminal according to any one of claims 3 to 6.

8. A health care support system, wherein
a medical-side information processor placed on the side of a medical expert and a health care support terminal placed on the side of a user are connected to a server through a network,
said health care support terminal comprising speech output means for outputting speech on the basis of speech synthesis or speech data, to make speech, acquire vital data related to a user directly or indirectly through auxiliary equipment, and automatically transmit the vital data to said server, and
said server storing at least user health related information constructed by managing said vital data for each user, to transmit at least said user health related information to said medical-side information processor in response to a request from the information processor.

9. A health care support system, wherein
a medical-side information processor placed on the side of a medical expert and a health care support terminal placed on the side of a user are connected to a server through a network,
said health care support terminal comprising speech output means for outputting speech on the basis of speech synthesis or speech data, to ask a user a question, acquire an answer to the question by information acquisition means for acquiring information returned from the user, and automatically transmit answer data representing the answer to the server, and
said server storing at least user health related information constructed by managing said answer data for each user, to transmit at least said user health related information to said medical-side information processor in response to a request from the information processor.

10. A health care support system, wherein
a medical-side information processor placed on the side of a medical expert and a health care support terminal placed on the side of a user are connected to a server through a network,
said health care support terminal comprising speech output means for outputting speech on the basis of speech synthesis or speech data, to ask the user a question, acquire an answer to the question by information acquisition means for acquiring information returned from the user, acquire vital data related to the user directly or indirectly through auxiliary equipment, and automatically transmit answer data representing the answer and the vital data to said server, and
said server storing at least user health related information constructed by managing said answer data and said vital data for each user, to transmit at least said user health related information to said medical-side information processor in response to a request from the information processor.

11. The health care support system according to any one of claims 8 to 10, wherein
said server incorporates examination data at the time of hospital visit of the user which is inputted by said medical-side information processor as the contents of the user health related information.

12. A pet-type health care support terminal having a imitative biological form, comprising:
speech output means for outputting speech on the basis of speech synthesis or speech data;
means for acquiring vital data related to a user directly or indirectly through auxiliary equipment;
means for asking the user a question using said speech output means, detecting information returned from the user, and acquiring an answer to the question;
means for making wireless Net connection, to automatically transmit said vital data and answer data representing the answer;
connection means for automatically making, when a Net connection request is recognized by speech recognition, the wireless Net connection; and
means for outputting information obtained by the wireless Net connection by speech in said speech output means.

13. A pet-type health care support terminal having a imitative biological form, comprising:
speech output means for outputting speech on the basis of speech synthesis or speech data;
means for acquiring vital data related to a user directly or indirectly through auxiliary equipment;
means for asking the user a question using said speech output means, detecting information returned from the user, and acquiring an answer to the question;
means for making wireless Net connection, to automatically transmit said vital data or answer data representing said answer;
connection means for automatically making, when a switch provided in a predetermined portion of the face or the body in the imitative biological form is operated, the wireless Net connection; and
means for outputting information obtained by the wireless Net connection by speech in said speech output means.

14. A pet-type health care support terminal having a imitative biological form, comprising:
speech output means for outputting speech on the basis of speech synthesis or speech data;
means for acquiring vital data related to a user directly or indirectly through auxiliary equipment;
means for asking the user a question using said speech output means, detecting information returned from the user, and acquiring an answer to the question;
means for making wireless Net connection, to automatically transmit said vital data and answer data representing the answer; and
notification means holding information as to which of “YES” and “NO” is an answer requiring attention with respect to the contents of each of questions for notifying, when the answer is the answer requiring attention, the user of the answer.

15. A pet-type health care support terminal having a imitative biological form, comprising:
speech output means for outputting speech on the basis of speech synthesis or speech data;
means for acquiring vital data related to a user directly or indirectly through auxiliary equipment;
notification means holding values requiring attention with respect to one or a plurality of vital data for notifying, when the vital data related to the user exceeds the value requiring attention, the user of the vital data;
means for asking the user a question using said speech output means, detecting information returned from the user, and acquiring an answer to the question; and
means for making wireless Net connection, to automatically transmit said vital data and said answer data.

16. The pet-type health care support terminal according to claim 12, wherein
the answer to the question is acquired in the speech recognition means.

17. The pet-type health care support terminal according to claim 13, further comprising
speech recognition means,
the answer to the question being acquired in the speech recognition means.

18. The pet-type health care support terminal according to claim 14, further comprising
speech recognition means,
the answer to the question being acquired in the speech recognition means.

19. The pet-type health care support terminal according to claim 15, further comprising
speech recognition means,
the answer to the question being acquired in the speech recognition means.

20. The pet-type health care support terminal according to claim 12, wherein
user feature information representing the features of the user is acquired from the contents of a conversation with the user or the contents of the question and the answer using speech recognition and speech output.

21. The pet-type health care support terminal according to claim 20, wherein
Net retrieval is performed using the user feature information as a key.

22. The health care support system according to claim 8, wherein
the health care support terminal is the pet-type health care support terminal according to any one of claims 12 to 21.

23. The health care support system according to claim 9, wherein
the health care support terminal is the pet-type health care support terminal according to any one of claims 12 to 21.

24. The health care support system according to claim 10, wherein
the health care support terminal is the pet-type health care support terminal according to any one of claims 12 to 21.

25. The health care support system according to claim 8, wherein
the health care support terminal is a pet-type health care support terminal having a imitative biological form.

26. The health care support system according to claim 9, wherein
the health care support terminal is a pet-type health care support terminal having a imitative biological form.

27. The health care support system according to claim 10, wherein
the health care support terminal is a pet-type health care support terminal having a imitative biological form.

28. The health care support system according to claim 8, wherein
a nutritionist-side information processor placed on the side of an expert related to nutrition is connected to said server through a network, and
said server incorporates calorie intake information related to calories taken in which is inputted in said nutritionist-side information processor as the contents of the user health related information.

29. The health care support system according to claim 9, wherein
a nutritionist-side information processor placed on the side of an expert related to nutrition is connected to said server through a network, and
said server incorporates calorie intake information related to calories taken in which is inputted in said nutritionist-side information processor as the contents of the user health related information.

30. The health care support system according to claim 10, wherein
a nutritionist-side information processor placed on the side of an expert related to nutrition is connected to said server through a network, and
said server incorporates calorie intake information related to calories taken in which is inputted in said nutritionist-side information processor as the contents of the user health related information.

31. The health care support system according to claim 28, wherein
the calorie intake information registered in said server is transmitted to the health care support terminal placed on the side of the user, and
the calories taken in are reported by speech at the health care support terminal.

32. The health care support system according to claim 29, wherein
the calorie intake information registered in said server is transmitted to the health care support terminal placed on the side of the user, and
the calories taken in are reported by speech at the health care support terminal.

33. The health care support system according to claim 30, wherein
the calorie intake information registered in said server is transmitted to the health care support terminal placed on the side of the user, and
the calories taken in are reported by speech at the health care support terminal.

34. A vital data acquisition device comprising:
a plurality of data communication ports for receiving vital data outputted by each vital measurement device;
an instruction key for selecting the vital measurement device and issuing a data registration instruction;
display means for displaying a message; and
means for transmitting data acquired from said vital measurement device by wireless.

35. The vital data acquisition device according to claim 34, further comprising
a numeric input key for manually inputting data.

36. The vital data acquisition device according to claim 35, wherein
the date can be inputted using said numeric input key, and
vital data and data representing the inputted date are transmitted by wireless when the key for issuing said data registration instruction is operated in a case where the date is displayed on the display means.

37. The vital data acquisition device according to claim 34, further comprising
a button meaning emergency, to transmit information meaning emergency by wireless when the button is operated.

38. The vital data acquisition device according to claim 34, further comprising
a button meaning consultation, to transmit information meaning consultation by wireless when the button is operated.

39. A vital data acquisition Net transmission system, comprising
the vital data acquisition device according to claim 34; and
a terminal receiving data transmitted by wireless from said vital data acquisition device and transmitting said data to the server at the time of Net connection.

40. A vital data acquisition Net transmission system, comprising
the vital data acquisition device according to claim 37; and
a terminal for making connection to a predetermined contact address when the information meaning emergency transmitted by wireless from said vital data acquisition device is received, to perform notification processing.

41. A vital data acquisition Net transmission system, comprising
the vital data acquisition device according to claim 38; and
a terminal for making connection to a predetermined contact address when the information meaning consultation transmitted by wireless from said vital data acquisition device is received, to perform telephone conversation processing.

42. The vital data acquisition Net transmission system according to claim 39, wherein
said terminal comprises Net connection means by wireless.

43. The vital data acquisition Net transmission system according to claim 39, wherein
said terminal has a imitative biological form.

44. The vital data acquisition Net transmission system according to claim 39, wherein
said terminal outputs speech on the basis of speech synthesis or speech data.

45. The vital data acquisition Net transmission system according to claim 44, wherein
said terminal notifies, when there is one, which has not been acquired yet, of the vital data which are scheduled to be acquired, the user of the vital data by speech output.

46. The vital data acquisition device according to claim 34, wherein
wireless transmission is performed simultaneously using both infrared rays and radio waves.

47. The vital data acquisition Net transmission system according to claim 39, wherein
both infrared rays and radio waves are simultaneously received.

48. A health care support method, wherein
a medical-side information processor placed on the side of a medical expert, a portable information terminal with a camera placed on the side of a user, and a nutritionist-side information processor placed on the side of an expert related to nutrition are connected to a server through a network,
the user photographing the contents of a meal to be taken at said portable information terminal with a camera, to transmit meal image data representing an image of the meal to said server,
said expert related to nutrition accepting the meal image data from said server in said nutritionist-side information processor, to display the image, and calculating calories taken in, to transmit calorie intake information related to the calories taken in to said server, and
said server storing the calorie intake information as one of user health related information, to transmit at least said user health related information to said medical-side information processor in response to a request from the information processor.

49. The health care support method according to claim 48, wherein
the user transmits to said server meal memo data representing a meal memo together with said meal image data, and
said expert related to nutrition accepts the meal image data and the meal memo data from said server in said nutritionist-side information processor to display the meal image and the meal memo, to calculate calories taken in.

50. The health care support method according to claim 48, wherein
the user photographs, with respect to one meal, at least the whole contents of the meal, to transmit meal image data representing an image of the meal to said server, and
said expert related to nutrition accepts said meal image data with respect to one meal from said server in said nutritionist-side information processor to display the meal image, to calculate calories taken in.

51. The health care support method according to claim 48, wherein
the user photographs, with respect to one meal, at least a state where the meal has not been taken and a state where the meal is left over, to transmit a plurality of meal image data to said server, and
said expert related to nutrition accepts said plurality of meal image data with respect to one meal from said server in said nutritionist-side information processor to display the meal image, to calculate calories taken in.

52. The health care support method according to claim 50, wherein
the user photographs, with respect to one meal, at least the whole contents of the meal and parts of contents of the meal, to transmit a plurality of meal image data to said server, and
said expert related to nutrition accepts said plurality of meal image data with respect to one meal from said server in said nutritionist-side information processor to display the meal image, to calculate calories taken in.

53. The health care support method according to claim 48, wherein
photographing time information related to the time when the meal is photographed is added to the meal image data.

54. The health care support method according to claim 53, wherein
said server estimates the time when the user takes the meal on the basis of the photographing time information added to said meal image data.

55. The health care support method according to claim 53, wherein
a health care support terminal placed on the side of the user is connected to the server through the network,
said health care support terminal transmitting blood sugar level data representing the blood sugar level of the user, together with blood sugar level data acquisition time information related to the time when the blood sugar level data is acquired, to said server, and
said server estimating the type of the blood sugar level data on the basis of the photographing time information added to said meal image data and the blood sugar level data acquisition time information.

56. The health care support method according to claim 48, wherein
information indicating that no meal is taken can be transmitted to said server in place of the meal image.

57. A portable information terminal with a camera, comprising:
means for adding data representing the photographing date to an image obtained by photographing in the camera and recording the image and the date data;
means for accepting the designation of input of the meal date;
means for thumbnailing the image picked up on the day on the basis of the inputted meal date, to display the thumbnailed image together with the photographing time;
means for accepting the designation of a plurality of designated thumbnailed images;
means for making Net connection, to transmit data representing said plurality of designated thumbnailed images.

58. The portable information terminal with a camera according to claim 57, wherein
information related to the photographing time added to data representing said meal image is also transmitted.

59. The portable information terminal with a camera according to claim 57, further comprising
designation means for designating an item indicating that no meal is taken, and
means for transmitting to said server information indicating that no meal is taken when the item is designated.
